(19) United States
(12) Patent Application Publication
(10) Pub. No.: US 2024/0061706 A1
(43) Pub. Date: Feb. 22, 2024

(54) TASK SUPPORT SYSTEM, TASK SUPPORT METHOD, AND INFORMATION STORAGE MEDIUM

(71) Applicant: Cybozu, Inc., Tokyo (JP)

(72) Inventors: Hideki IGARASHI, Yokohama-shi (JP); Hayato SHIMOJI, Ichinomiya-shi (JP); Ryotaro NAKAGAWA, Matsudo-shi (JP); Kota UCHIDA, Fujimino-shi (JP)

(21) Appl. No.: 18/449,700

(22) Filed: Aug. 14, 2023

(30) Foreign Application Priority Data
Aug. 17, 2022 (JP) 2022-130158

(51) Int. Cl. G06F 9/48

(52) U.S. Cl. CPC G06F 9/4881

(57) ABSTRACT

Provided is a task support system for supporting a user in tasks, the task support system including at least one processor configured to: display a notification screen relating to a notification received by the user in the task support system; receive, on the notification screen, a first operation relating to a notification-related task associated with the notification; and execute first task processing relating to the notification-related task based on the first operation.

### CROSS-REFERENCE TO RELATED APPLICATION

The present disclosure contains subject matter related to that disclosed in Japanese Patent Application JP 2022-130158 filed in the Japan Patent Office on Aug. 17, 2022 the entire contents of which are hereby incorporated by reference.

### BACKGROUND OF THE INVENTION

### 1. Field of the Invention

The embodiments disclosed herein relate to a task support system, a task support method, and an information storage medium.

### 2. Description of the Related Art

Hitherto, there has been known a task support system for supporting users in tasks. For example, in Japanese Patent Application Laid-open No. 2014-174773, a cloud-based task support system is described. In the task support system of Japanese Patent Application Laid-open No. 2014-174773, when a comment which is in some way related to a user is input, the user receives a notification indicating that the comment has been input. When the user selects a notification on a notification screen relating to the notification the user has received, the screen transitions to a transition destination screen for checking the details of the comment corresponding to the notification. The user performs a notification-related task associated with the notification on the transition destination screen.

However, in the technology of Japanese Patent Application Laid-open No. 2014-174773, when the user tries to check another notification after completing the notification-related task on the transition destination screen, the user is required to return to the notification screen from the transition destination screen, which takes time and effort by the user. It is conceivable to display the transition destination screen as a pop-up on the notification screen or as a tab separate from the notification screen, but even in such a case, it is required to close the pop-up or to switch tabs to display the notification screen after completing the notification-related task on the transition destination screen, which takes time and effort by the user.

### SUMMARY OF THE INVENTION

One object of the present disclosure is to reduce time and effort spent by a user in performing a notification-related task associated with a notification.

According to at least one aspect of the present disclosure, there is provided a task support system for supporting a user in tasks, the task support system including at least one processor configured to: display a notification screen relating to a notification received by the user in the task support system; receive, on the notification screen, a first operation relating to a notification-related task associated with the notification; and execute first task processing relating to the notification-related task based on the first operation.

### BRIEF DESCRIPTION OF THE DRAWINGS

FIG. 1 is a diagram for illustrating an example of a hardware configuration of a task support system.

FIG. 2 is a view for illustrating an example of a thread screen.

FIG. 3 is a view for illustrating an example of a notification screen.

FIG. 4 is a diagram for illustrating an example of functions implemented in a first embodiment of the present disclosure.

FIG. 5 is a table for showing an example of a user database.

FIG. 6 is a table for showing an example of a thread database.

FIG. 7 is a flow chart for illustrating an example of processing to be executed in the first embodiment.

FIG. 8 is a view for illustrating an example of a notification screen in a second embodiment of the present disclosure.

FIG. 9 is a diagram for illustrating an example of functions implemented in the second embodiment.

FIG. 10 is a flow chart for illustrating an example of processing to be executed in the second embodiment.

FIG. 11 is a diagram for illustrating an example of functions implemented in modification examples relating to the first embodiment.

FIG. 12 is a view for illustrating an example of rearrangement of a display area on the notification screen.

FIG. 13 is a view for illustrating an example of a notification screen in Modification Example 1-5.

FIG. 14 is a view for illustrating an example of a notification screen in Modification Example 1-6.

FIG. 15 is a view for illustrating an example of a notification screen in Modification Example 2-2.

FIG. 16 is a view for illustrating an example of a notification screen in Modification Example 2-3.

### DESCRIPTION OF THE EMBODIMENTS

### 1. First Embodiment

A first embodiment of the present disclosure is described as an example of an embodiment of a display control system according to the present disclosure. The first embodiment takes as an example a case in which the display control system is applied to a task support system for supporting users in tasks. Thus, in the first embodiment, “task support system” can be read as “display control system.” Examples of applications to systems other than the task support system are described later in “Other Modification Examples Relating to First Embodiment.”

### 1-1. Hardware Configuration of Task Support System

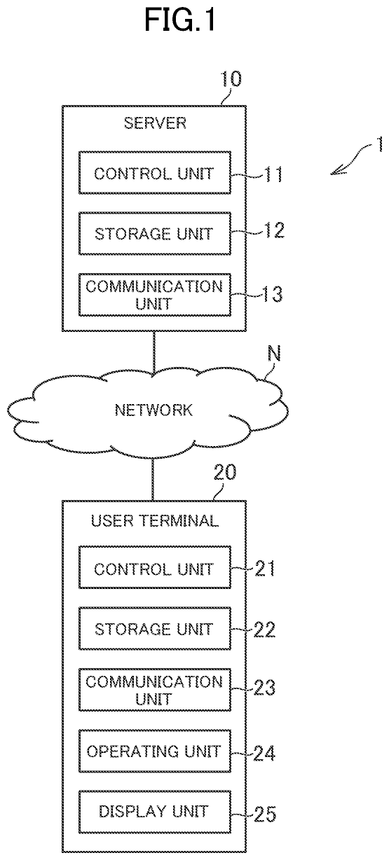

FIG. 1 is a diagram for illustrating an example of a hardware configuration of the task support system. For example, a task support system 1 includes a server 10 and a user terminal 20. The server 10 and the user terminal 20 are each connected to a network N, such as the Internet or a LAN.

The server 10 is a server computer. For example, the server 10 includes a control unit 11, a storage unit 12, and a communication unit 13. The control unit 11 includes at least one processor. The storage unit 12 includes a volatile memory such as a RAM, and a non-volatile memory such as a flash memory. The communication unit 13 includes at least one of a communication interface for wired communication or a communication interface for wireless communication.

The user terminal 20 is a computer of a user. For example, the user terminal 20 is a personal computer, a tablet terminal, or a smartphone. For example, the user terminal 20 includes a control unit 21, a storage unit 22, a communication unit 23, an operating unit 24, and a display unit 25. Hardware configurations of the control unit 21, the storage unit 22, and the communication unit 23 may be the same as those of the control unit 11, the storage unit 12, and the communication unit 13, respectively. The operating unit 24 is an input device, such as a mouse, a touch panel, or a keyboard. The display unit 25 is a liquid crystal display or an organic EL display.

Programs stored in the storage units 12 and 22 may be supplied through the network N. Hardware configurations of the server 10 and the user terminal 20 are not limited to the examples of FIG. 1. For example, a reading unit (for example, optical disc drive or memory card slot) for reading a computer-readable information storage medium or an input/output unit (for example, USB terminal) for directly connecting to an external device may be included. In this case, programs stored in the information storage medium may be supplied through intermediation of the reading unit or the input/output unit.

Further, the task support system 1 is only required to include at least one computer. The computers included in the task support system 1 are not limited to the example of FIG. 1. For example, the task support system 1 is not required to include the user terminal 20. In this case, the user terminal 20 is present outside the task support system 1, and the task support system 1 includes only the server 10. The task support system 1 may include the server 10 and another server computer.

### 1-2. Outline of First Embodiment

The task support system 1 provides the user with various functions for supporting tasks. The task support system 1 can be ready for any type of industry. The task support system 1 is sometimes called, for example, groupware. In the first embodiment, the task support system 1 of a cloud type is taken as an example, but the task support system 1 may be of any type, and may be of an on-premises type instead of the cloud type.

In the first embodiment, as an example of a function provided by the task support system 1, a thread function for communicating in a thread, which is a type of chat tool, is described. Other functions may also be provided, such as a schedule sharing function for sharing a schedule, a file sharing function for sharing a file, or a database sharing function for sharing a database. For example, when the user logs in to the task support system 1 by operating the user terminal 20, a thread screen showing the content of the thread is displayed on the display unit 25.

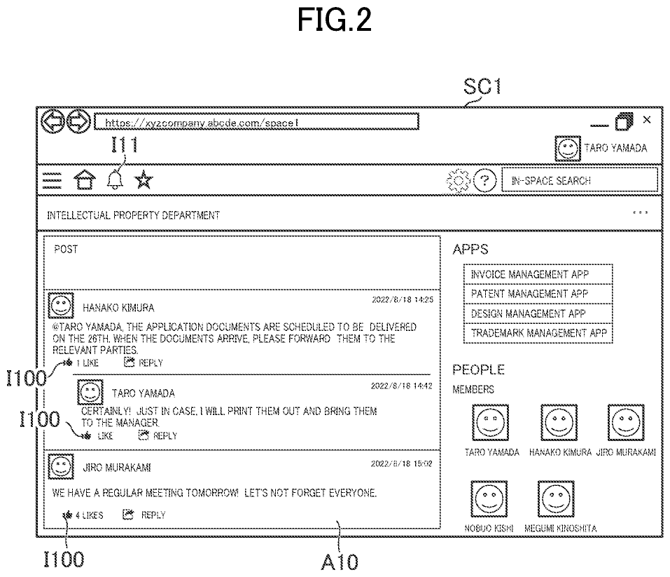

FIG. 2 is a view for illustrating an example of the thread screen. In the first embodiment, a case in which various screens including the thread screen are displayed on a browser of the user terminal 20 is described, but the various screens may be displayed on a dedicated program installed on the user terminal 20. For example, a message posted in the thread is displayed in a display area A10 of a thread screen SC1. The user can post a new message to the thread and react to a message posted in the thread by another user.

For example, when a message is posted in a thread relating to the user, or when a reaction is added to a message posted by the user, the user receives a notification from the task support system 1. “Notification” may also be referred to as “mention” or “alert.” In the first embodiment, a case in which there are two types of notifications, that is, a “to-me notification” and a “to-someone-else notification,” is described as an example, but there may only be one type of notification which does not distinguish between those notifications or there may be three or more types of notifications to distinguish the notifications in more detail.

The to-me notification is a notification received when the user is designated as an addressee. For example, when a message designating a certain user as an addressee is posted, the user receives the to-me notification. The to-someone-else notification is a notification received when the user is not designated as the addressee. For example, when a message that relates to a certain user is posted, but the user is not designated as the addressee, the user receives the to-someone-else notification. In the following description, when the to-me notification and the to-someone-else notification are not distinguished, the term “notification” is simply used. For example, the user can designate the addressee by inputting the name of another user to be designated as the addressee after the “@” signifying the designation of the addressee. The method of specifying the addressee itself is not limited to the example of the first embodiment, and another method may be used. For example, the user may designate the addressee by using a symbol other than “@,” or may designate the addressee from among a list of other users. For example, the user may designate the addressee by operating a radio button or a check box displayed near the name of another user.

In the example of FIG. 2, a message posted at 14:25 on Aug. 18, 2022, has “Taro Yamada” as the designated addressee, and hence “Taro Yamada” receives the to-me notification indicating that this message has been input. A message posted at 14:42 on Aug. 18, 2022, is a message by “Taro Yamada” himself, and hence “Taro Yamada” does not receive a notification. A message posted at 15:02 on Aug. 18, 2022, is posted in a thread relating to “Taro Yamada,” but “Taro Yamada” is not designated as the addressee, and hence “Taro Yamada” receives a to-someone-else notification indicating that this message has been posted.

In the first embodiment, the user also receives notifications regarding functions other than the thread function. For example, the user also receives notifications relating to a schedule sharing function, a file sharing function, a database sharing function, or other functions provided by the task support system 1. The user can check the notifications which he or she has received on the task support system 1. For example, when the user selects an icon I11, the display unit 25 displays a notification screen showing a list of the notifications received by the user.

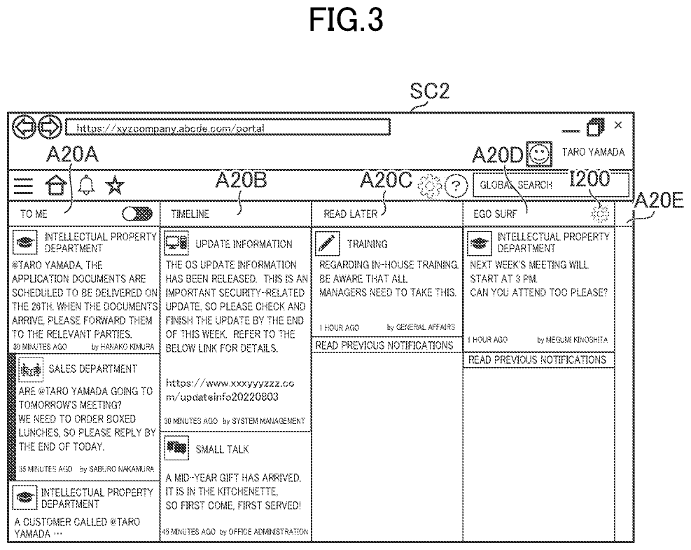

FIG. 3 is a view for illustrating an example of the notification screen. For example, a notification screen SC2 includes display areas A20A to A20E arranged horizontally. In the following description, when the display areas A20A to A20E are not distinguished, the display areas A20A to A20E are simply referred to “display area A20.” In the example of FIG. 3, five display areas A20 are illustrated, but the number of display areas A20 may be any number, and is not limited to five. For example, the notification screen SC2 may include one to four or six or more display areas A20. Display areas A20 that do not fit on the notification screen SC2 can be displayed by scrolling horizontally.

A display condition is associated with the display area A20. The display condition is a determination criterion for determining whether or not to display the notification in the display area A20. The display condition can also be referred to as “filter condition” or “narrowing-down condition.” The display condition can also be referred to as a query for searching for the notification to be displayed in the display area A20. The display condition may be only one condition, or may be a combination of a plurality of conditions. In the first embodiment, a case in which a display condition is associated with each display area A20 and the display condition corresponds to the display area A20 on a one-to-one basis is described, but a certain display condition may be common to a plurality of display areas A20.

The display condition may be any condition as long as the display condition can be determined based on some kind of data relating to the notification. For example, the display condition is a condition relating to supplementary data of the notification or the content of the notification. The supplementary data is not the content of the notification itself, but is data attached to the notification. For example, the supplementary data is the type of the notification, such as whether the notification is the to-me notification or the to-someone-else notification, or a flag to be read later, which is described later. The content of the notification is a character string (text) indicating the notification itself. In the first embodiment, it is assumed that notifications satisfying the display condition are vertically arranged in chronological order from top to bottom in the display area A20.

For example, the display area A20A is associated with the display condition “type of notification is a to-me notification.” In the example of FIG. 3, the to-me notifications received by “Taro Yamada” are vertically arranged in chronological order from top to bottom of the display area A20A. In the first embodiment, unread to-me notifications and read to-me notifications can be distinguished in the display area A20A. For example, the to-me notification relating to the “sales department” arranged second from the top in the display area A20A is unread. The left edge of this to-me notification is given a color indicating that the notification has not been read (in FIG. 3, a color schematically indicated by halftone dots).

For example, the display area A20B is associated with the display condition “is a timeline notification.” In the example of FIG. 3, the timeline notifications received by “Taro Yamada” are vertically arranged in chronological order from top to bottom in the display area A20B. The display area A20C is associated with the display condition “read-later flag is on.” In the example of FIG. 3, notifications classified as “read later” by “Taro Yamada” are vertically arranged in chronological order from top to bottom in the display area A20C.

For example, the display area A20D is associated with the display condition “main text of the notification includes the keyword ‘Yamada’.” In the example of FIG. 3, notifications including the keyword “Yamada” in the main text instead of in the addressee of the notification are vertically arranged in chronological order from top to bottom in the display area A20D. The details of the display area A20E are not shown in FIG. 3, but the display area A20E is associated with a display condition different from the display conditions of the display areas A20A to A20D. Notifications that do not fit in the display areas A20A and A20B of FIG. 3, for example, can be displayed by scrolling vertically. Similarly to the display areas A20C and A20D of FIG. 3, past notifications can also be read.

In the first embodiment, it is assumed that the display conditions of the display areas A20A to A20C of the first to third columns from the left are determined in advance on the task support system 1 side. The user can freely designate the display conditions of the display areas A20D and A20E in the fourth and subsequent columns. For example, by selecting an icon I200, the user can change the display condition or delete the display area A20 itself. The user can also designate a new display condition and add a new display area A20 to a sixth column. The order of the display areas A20 may be changeable as in modification examples described later.

Thus, in the first embodiment, the display unit 25 displays the notification screen SC2 such that, in each of the plurality of display areas A20, the notifications satisfying the display condition associated with the display area A20 are arranged.

This enables a notification satisfying a certain display condition and a notification satisfying another display condition to be displayed on the same notification screen SC2. As a result, the user is not required to re-designate a display condition each time in order to switch the display of the notification screen SC2, and hence user convenience is improved. The task support system 1 is now described in more detail below.

### 1-3. Functions Implemented in First Embodiment

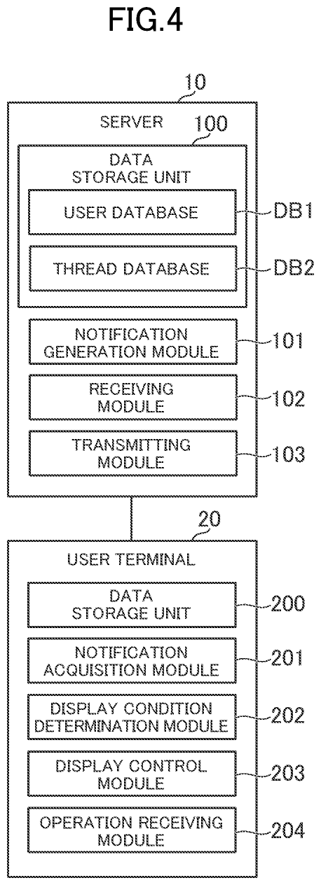

FIG. 4 is a diagram for illustrating an example of functions implemented in the first embodiment.

### 1-3-1. Functions Implemented by Server

For example, the server 10 includes a data storage unit 100, a notification generation module 101, a receiving module 102, and a transmitting module 103. The data storage unit 100 is implemented by the storage unit 12. The notification generation module 101, the receiving module 102, and the transmitting module 103 are each implemented by the control unit 11.

[Data Storage Unit]

The data storage unit 100 stores data for supporting users in tasks. For example, the data storage unit 100 stores a user database DB1 and a thread database DB2.

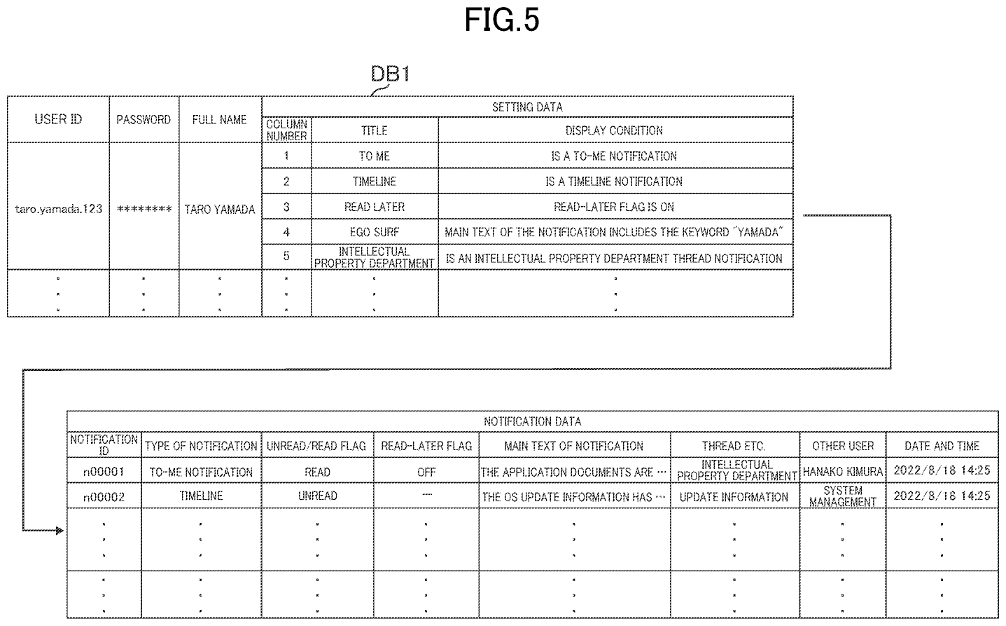

FIG. 5 is a table for showing an example of the user database DB1. The user database DB1 is a database in which various kinds of data relating to users are stored. For example, the user database DB1 stores a user ID, a password, a user name, setting data, and notification data. The data stored in the user database DB1 may be any data relating to the user, and is not limited to the example of FIG. 5. For example, the user database DB1 may store data such as an email address, an affiliation, or a job position of the user, or a thread in which the user is participating.

The user ID and password are authentication information required for login. The name of the user is used when the addressee is designated. The setting data is data relating to a setting of the display area A20. The setting data may have any format, for example, JSON format or XML format. For example, the setting data indicates a column number, a title, and a display condition of the display area A20. When the user designates a new display condition and adds a display area A20, the setting data is updated so that a new column number, a new title, and a new display condition are added. When the user deletes an existing display area A20, the setting data is updated so that the column number, the title, and the display condition corresponding to the display area A20 are deleted.

In the example of FIG. 5, in column number “1” of the setting data for “Taro Yamada,” the title “to me” and the display condition “is a to-me notification” are associated with each other. In column number “2,” the title “timeline” and the display condition “is a timeline notification” are associated with each other. In column number “3,” the title “read later” and the display condition “read-later flag is on” are associated with each other. In column number “4,” the title “Ego Surf” and the display condition “main text of the notification includes the keyword ‘Yamada’” are associated with each other. In column number “5,” the title “intellectual property department” and the display condition “is an intellectual property department thread notification” are associated with each other.

The notification data includes various kinds of information on the notifications received by the user. For example, the notification data includes a notification ID, a type of notification, an unread/read flag, a read-later flag, a main text of the notification, information on the thread or the like that caused the notification, name of the other user who performed an action that caused the notification, and the date and time of the notification. The notification data is generated by the notification generation module 101, which is described later, and stored in the user database DB1. Of the notification data, the data other than the main text of the notification corresponds to the above-mentioned supplementary data.

The notification ID is information that can uniquely identify the notification. The type of notification indicates whether the notification is a to-me notification or a to-someone-else notification. The type of notification may indicate whether or not the notification is a timeline notification. The unread/read flag indicates whether the notification has been read or unread. The unread/read flag is shown as “unread” when the notification is generated, and is shown as “unread” when the notification is displayed on the notification screen SC2.

The read-later flag indicates whether or not the notification is classified as a read-later notification. For example, when the user performs, on the notification displayed on the notification screen SC2, an operation indicating that the notification is to be read later, the read-later flag of the notification is turned on. The read-later flag of the notification may also be turned on by dragging and dropping the notification onto the display area A20 associated with the display condition relating to the read-later flag.

The main text of the notification is the specific content of the notification. In the first embodiment, a case in which the main text of the notification and the content of the message are the same is described, but the main text of the notification may show only a beginning portion of the message. The main text of the notification may also be a summary of the message. The information on the thread or the like indicates a thread ID and a message ID corresponding to the thread and the message that caused the notification. The name of the other user and the date and time of the notification are the name of the other user who posted the message or made the reaction that caused the notification, and the date and time at that time.

The notification data may be stored in another database other than the user database DB1. The another database may be a database dedicated to notifications in which various kinds of data relating to notifications are stored. The information included in the notification data may be any information, and is not limited to the example of FIG. 5. In a case in which the notification is to have attributes other than attributes such as the types or read/unread flag shown in FIG. 5, those other attributes may be included in the notification data. Examples of such other attributes include a bookmark indicating that the notification is important, or the department or job position of the other user who performed the action that caused the notification.

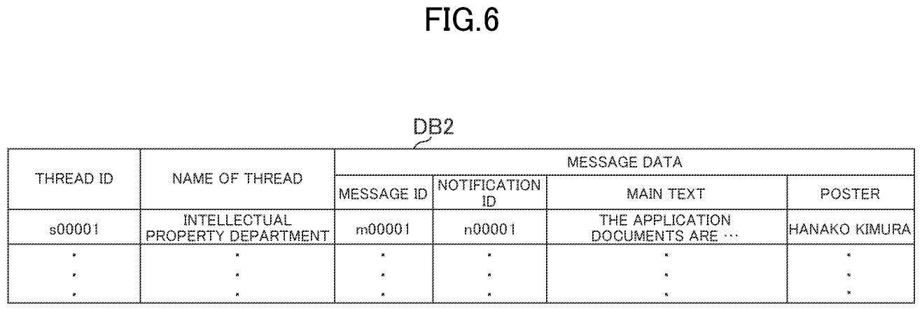

FIG. 6 is a table for showing an example of the thread database DB2. The thread database DB2 is a database in which the various messages posted in a thread are stored. For example, a thread ID, a thread name, and message data are stored. The data stored in the thread database DB2 may be any data relating to the thread, and is not limited to the example of FIG. 6. For example, other data such as an attached file posted in the thread may be stored.

The thread ID is information that can uniquely identify the thread. Instead of the thread ID, the thread may be identified by using other information, such as a URL for displaying the thread or the name of the thread. The message data is data relating to the messages posted to the thread. For example, the message data indicates the message ID, the notification ID, the main text of the message, and the poster of the message. The message data may include other information such as the thread in which the message is posted, the date and time, and the addressee of the notification.

The message ID is information that can uniquely identify a message within a thread. The message ID is associated with the notification ID of the notification performed when the message is input. The message ID may be associated with not only the notification ID but also other information such as the addressee of the notification. In the first embodiment, a case in which the main text of the message is the same as the main text of the notification is described, but the main text of the notification may be only a part of the message. The message data may include information such as the user ID and the number of reactions of the user who reacted to the message.

The data stored in the data storage unit 100 is not limited to the above-mentioned examples. The data storage unit 100 can store various kinds of data relating to the task support. For example, the data storage unit 100 stores data required for displaying each screen. For example, the data storage unit 100 stores data relating to functions other than the thread function. The notification data of the notifications relating to the other functions is also stored in the user database DB1.

[Notification Generation Module]

The notification generation module 101 generates the notification data of the notifications received by the user. Publicly known processing can be applied as the method of generating the notification data. For example, when a certain user performs a predetermined action, the notification generation module 101 generates the notification data of the notification to be received by a certain other user relating to the action. The notification generation module 101 stores the user ID of the certain other user and the generated notification data in association with each other in the user database DB1. A method employed in publicly known groupware, for example, can be used as the method of managing this series of processes and the notification data.

In the first embodiment, when a certain user posts a message to a thread, the notification generation module 101 generates the notification data of the notification to be received by the other users relating to the thread. The notification generation module 101 generates the notification data to be received as a to-me notification by the other users designated as the addressee in the message, and the notification data to be received as a to-someone-else notification by the other users participating in the thread who were not designated as the addressee, and stores the generated notification data in the user database DB1 in association with the user IDs of those other users. It is assumed that the user IDs of the other users participating in the thread are stored in the user database DB1 or the thread database DB2.

The notification generation module 101 may similarly generate notification data when an action to be notified to a certain user is performed in a function other than the thread function, and store the generated notification data in the user database DB1 in association with the user ID of the user. For example, when a record in the database of a database sharing function is newly created, changed, or deleted, the notification generation module 101 may generate a notification to be received by the users related to the database. For example, when some sort of comment is registered in a record in the database, a notification to be received by the users related to the comment may be generated. In addition, when the notification is performed by using other means such as email in addition to notification on the notification screen SC2, the notification generation module 101 may generate a notification by the other means and transmit the generated notification to the users who are to receive the notification.

[Receiving Module]

The receiving module 102 receives various kinds of data from the user terminal 20. For example, the receiving module 102 receives a display request for displaying the notification screen SC2 from the user terminal 20. The display request is performed by transmitting data having a predetermined format that indicates display of the notification screen SC2. The display request includes the user ID of the user who is currently logged in from the user terminal 20. The receiving module 102 also receives data other than the display request for the notification screen SC2. For example, the receiving module 102 receives data indicating the details of the operations performed on the various screens. When the user selects a notification on the notification screen SC2, the receiving module 102 receives the notification ID of the selected notification.

[Transmitting Module]

The transmitting module 103 transmits various kinds of data to the user terminal 20. For example, the transmitting module 103 transmits the display data of the notification screen SC2 to the user terminal 20. The display data is data for causing the user terminal 20 to display some sort of screen. When various screens are to be displayed on the browser as in the first embodiment, the display data is HTML data, for example. When the various screens are to be displayed on a dedicated application, the display data may be data having a format defined by the application (for example, image data of the JPEG format).

In the first embodiment, it is assumed that the user terminal 20 side executes the determination regarding whether or not the notification satisfies the display condition. Thus, the display data of the notification screen SC2 includes all or part of the setting data of the display area A20 and all or part of the notification data of a predetermined number of notifications so that the determination can be executed on the user terminal side. For example, when a certain user has transmitted a request to display the notification screen SC2, the transmitting module 103 acquires a predetermined number (for example, about 100) of the most recent pieces of notification data among the setting data associated with the user ID of the user. The transmitting module 103 transmits display data including the acquired setting data and notification data to the user terminal 20.

The transmitting module 103 may transmit the setting data and the notification data to the user terminal 20 as separate data from the display data of the notification screen SC2. Further, the display data of the notification screen SC2 includes scripts for executing processing for determining whether or not the notification satisfies the display condition, processing for arranging the notifications in the display area A20, and other processing required for displaying the notification screen SC2. Further, when a request to display a screen other than the notification screen SC2 is performed, the transmitting module 103 generates the display data of the other screen and transmits the generated display data to the user terminal 20.

### 1-3-2. Functions Implemented by User Terminal

For example, the user terminal 20 includes a data storage unit 200, a notification acquisition module 201, a display condition determination module 202, a display control module 203, and an operation receiving module 204. The data storage unit 200 is implemented by the storage unit 22. The notification acquisition module 201, the display condition determination module 202, the display control module 203, and the operation receiving module 204 are each implemented by the control unit 21.

[Data Storage Unit]

The data storage unit 200 stores data required for supporting users in tasks. For example, data storage unit 200 stores a browser for displaying various screens relating to the task support system 1. For example, the data storage unit 200 stores an application dedicated to the task support system 1. For example, the data storage unit 200 stores the display data of each screen received from the server 10. In the first embodiment, the processing for the display condition determination module 202 and the display control module 203 is executed as processing for scripts included in the display data.

[Notification Acquisition Module]

The notification acquisition module 201 acquires a notification received by the user. Acquiring a notification means acquiring the notification data. In the first embodiment, the notification acquisition module 201 is included in the user terminal 20, and hence receiving notification data from the server 10 corresponds to acquiring the notification. For example, the notification acquisition module 201 acquires the notification by receiving the display data of the notification screen SC2 from the server 10. When the notification data is data different from the display data, receiving the notification data, which is the different data, may correspond to acquiring the notification. The notification acquisition module 201 may acquire a plurality of notifications at a time or one notification at a time. In the first embodiment, it is assumed that the notification acquisition module 201 acquires a predetermined number of notifications (for example, 100) at a time.

In the first embodiment, as an example of the information received by the user, a notification received by the user in the task support system 1 that supports the user in tasks is described. Thus, in the first embodiment, “notification” can be read as “information received by the user,” and “notification acquisition module 201” can be read as “information acquisition module.” The information received by the user may be information other than a notification, and is not limited to a notification. For example, the information received by the user may be an email, or a message that uses other means such as SMS, an SNS, or a messaging app. Examples of other information are described later in “Other Modification Examples Relating to First Embodiment.”

For example, the information received by the user may not be original data itself, but may be a summary of the original data in another format. The notification is also an example of the message being the original data summarized in another format. A preview of an email, which is described later, is also an example of a summary in the sense that only the minimum amount of information is displayed. As another example, information displayed in a system in which specific parties communicate to and from each other, such as the task support system 1, may correspond to the information received by the user. Instead of a summary, the information received by the user may be the original data itself, or may be information for communicating to and from an unspecified number of parties.

[Display Condition Determination Module]

The display condition determination module 202 determines whether or not the notification satisfies the display condition associated with each of the plurality of display areas A20 on the notification screen SC2. The display condition determination module 202 may perform the determination on each of a plurality of notifications, or perform the determination on only one notification. For example, the display condition determination module 202 refers to the setting data included in the display data of the notification screen SC2, and identifies each display condition. The display condition determination module 202 then executes a script included in the display data to determine, for each display area A20, whether or not each of a predetermined number of notifications satisfies the display condition associated with the display area A20.

In the first embodiment, the notification screen SC2 for displaying notifications in the task support system 1 is an example of a display screen. Thus, in the first embodiment, “notification screen SC2” can be read as “display screen.” The display screen may be a screen for displaying information other than notifications. For example, the display screen may be a screen for displaying a list of received emails in email software, or a screen for displaying a list of received messages by other means such as an SMS, an SNS, or a message app. Examples of other display screens are described later in “Other Modification Examples Relating to First Embodiment.”

For example, when the type of the notification is defined as the display condition, the display condition determination module 202 determines whether or not the notification satisfies the display condition by determining whether or not the notification is of the type indicated by the display condition. In the example of FIG. 5, in the setting data of “Taro Yamada,” the display condition “type of notification is a to-me notification” is associated with the column number “1,” and hence the display condition determination module 202 determines whether or not the notification satisfies the display condition by determining whether or not the type of the notification is a to-me notification. For example, in the example of FIG. 5, in the setting data of “Taro Yamada,” the display condition “is a timeline notification” is associated with the column number “2,” and hence the display condition determination module 202 determines whether or not the notification satisfies the display condition by determining whether or not the type of the notification is a timeline.

For example, when a flag value is defined as the display condition, the display condition determination module 202 determines whether or not the notification satisfies the display condition by determining whether or not the flag value of the notification is the flag value indicated by the display condition. In the example of FIG. 5, in the setting data of “Taro Yamada,” the display condition “read-later flag is on” is associated with the column number “3,” and hence the display condition determination module 202 determines whether or not the notification satisfies the display condition by determining whether or not the read-later flag of the notification is on.

The display condition may correspond to displaying only unread notifications in the display area A20. In this case, the display condition determination module 202 may determine whether or not the notification satisfies the display condition by determining whether or not the unread/read flag of the notification indicates that the notification is unread. Conversely, the display condition may correspond to displaying only read notifications in the display area A20. In this case, the display condition determination module 202 may determine whether or not the notification satisfies the display condition by determining whether or not the unread/read flag of the notification indicates that the notification has been read.

For example, when a keyword is defined as the display condition, the display condition determination module 202 determines whether or not the notification satisfies the display condition by determining whether or not the notification includes the characters indicated by the display condition. In the example of FIG. 5, in the setting data of “Taro Yamada,” the display condition “main text of the notification includes the keyword ‘Yamada’” is associated with the column number “4,” and hence the display condition determination module 202 determines whether or not the notification satisfies the display condition by determining whether or not the characters “Yamada” are included in the main text of the notification.

For example, when the thread that caused the notification is defined as the display condition, the display condition determination module 202 determines whether or not the notification satisfies the display condition by determining whether or not the notification is a notification from a source indicated by the display condition. In the example of FIG. 5, the display condition “is an intellectual property department thread notification” is associated with the column number “5,” and hence the display condition determination module 202 determines whether or not the notification satisfies the display condition by determining whether or not the thread that caused the notification is an intellectual property department thread.

The method of determining the display condition is not limited to the above-mentioned examples. It suffices that the display condition determination module 202 determines whether or not the notification satisfies the display condition by a determination method corresponding to each individual display condition. For example, when the date and time of the notification is defined as the display condition, the display condition determination module 202 may determine whether or not the notification satisfies the display condition by determining whether or not the date and time of the notification is a predetermined date and time.

For example, when the other user who caused the notification is defined as the display condition, the display condition determination module 202 may determine whether or not the notification satisfies the display condition by determining whether or not the other user included in the notification data is a predetermined person (for example, a person in a predetermined department or having a predetermined job position). As another example, the display condition determination module 202 may determine whether the notification satisfies another display condition, such as the number of characters in the main text of the notification, the presence or absence of an attached file, or the number of reactions.

[Display Control Module]

The display control module 203 displays the various screens in the task support system 1 on the display unit 25. For example, the display control module 203 displays the various screens on the display unit 25 based on the display data received from the server 10. In the first embodiment, processing for displaying the notification screen SC2 in particular is described.

In the first embodiment, the display control module 203 displays the notification screen SC2 such that, in each of the plurality of display areas A20, the notifications determined to satisfy the display condition associated with the display area A20 are arranged. For example, the display control module 203 displays the notification screen SC2 such that each of the plurality of display areas A20 is arranged in a horizontal direction, and the information determined to satisfy the display conditions associated with the display areas A20 is arranged in a vertical direction of each of the plurality of display areas A20.

The horizontal direction is an example of a first direction. The vertical direction is an example of a second direction. Thus, in the first embodiment, “horizontal direction” can be read as “first direction,” and “vertical direction” can be read as “second direction.” The second direction is a direction orthogonal to the first direction. The first direction and the second direction are not limited to the examples described in the first embodiment. For example, the first direction may be the vertical direction and the second direction may be the horizontal direction.

It is not required that the display areas A20 be arranged in the first direction. For example, the display areas A20 may be arranged in the upper left, upper right, lower left, and lower right of the notification screen SC2, respectively. For example, each of the plurality of display areas A20 may be arranged in a randomly determined position on the notification screen SC2. The widths of the display areas A20 may be different from each other. The user may designate the width of the display areas A20. The display areas A20 may have any shape, and are not limited to a rectangular shape as in FIG. 3. For example, the display areas A20 may have other shapes, such as a square shape, a rounded rectangular shape, or a circular shape.

Further, it is not required that the notification be arranged in the second direction in the display area A20. For example, when the horizontal width of the notification is shorter than the horizontal width of the display area A20, the notification may be arranged in the first direction in the display area A20. The order in which the notifications are sorted in the display area A20 is not limited to a chronological order as in the first embodiment, and the notifications may be sorted based on any sorting condition. For example, the notifications in the display area A20 may be arranged based on another sorting condition, for example, thread order, order of other users who performed an action that caused the notifications, order based on the character string of the notifications, or order based on the type of the notifications. For example, in the display area A20, the notifications may be arranged in a randomly determined order without defining a sorting condition.

In the first embodiment, the display control module 203 displays, in at least one display area A20 of the plurality of display areas A20, unread notifications determined to satisfy the display condition associated with the display area A20 and read notifications determined to satisfy the display condition associated with the display area A20 in such a manner that the unread notifications and the read notifications are distinguishable from each other. In the example of FIG. 3, the display control module 203 displays unread to-me notifications and read to-me notifications in the display area A20A in such a manner that those notifications can be distinguished from each other by the presence or absence of a color. The display control module 203 distinguishes between the unread to-me notifications and the read to-me notifications by adding a predetermined color to the notifications having an unread/read flag indicating that the notification has not been read (in FIG. 3, the notification from the sales department in the display area A20A).

The method of distinguishing between unread/read may be another method, and is not limited to the presence or absence of a color. For example, the display control module 203 may distinguish between unread/read by differentiating the background color of the notification, the size of the notification itself, the character color of the notification, the character size of the notification, or the shape of the notification. For example, the display control module 203 may distinguish between unread/read by switching between a state displaying only unread notifications and a state displaying both unread and read notifications. For example, the display control module 203 may distinguish between unread/read notifications in the display areas A20B to A20E instead of the display area A20A.

[Operation Receiving Module]

The operation receiving module 204 receives various operations in the task support system 1. For example, the operation receiving module 204 receives an operation performed on the thread screen SC1 or the notification screen SC2. Details of the operation received by the operation receiving module 204 are transmitted to the server 10 as appropriate. For example, when the icon I11 is selected, the operation receiving module 204 transmits a request to display the notification screen SC2 to the server 10. For example, when a notification on the notification screen SC2 is selected, the operation receiving module 204 transmits, to the server 10, a request to display the thread screen SC1 of the thread in which the message indicated by the notification is posted.

### 1-4. Processing to be Executed in First Embodiment

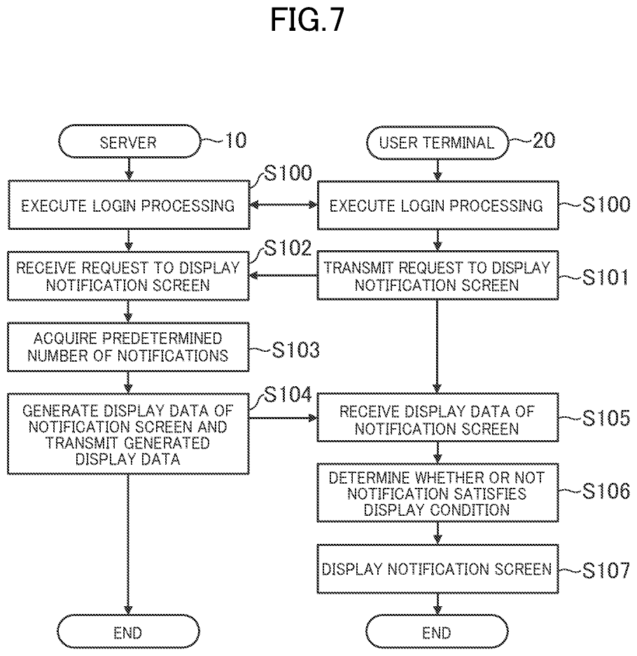

FIG. 7 is a flow chart for illustrating an example of processing to be executed in the first embodiment. In FIG. 7, of the processing to be executed by the task support system 1, the processing for displaying the notification screen SC2 is mainly illustrated. The processing of FIG. 7 is executed by the control units 11 and 21 executing programs stored in the storage units 12 and 22, respectively.

As illustrated in FIG. 7, login processing for causing the user to log in is executed between the server 10 and the user terminal 20 (Step S100). In Step S100, the user terminal 20 transmits, to the server 10, the user ID and the password that have been input by the user. The server 10 refers to the user database DB1 to verify validity of the user ID and the password. When the login processing is successful, the user can use the groupware. Processing for displaying the notification screen SC2 is described below.

When the icon I11 is selected on the thread screen SC1 or another screen, the user terminal 20 transmits a request to display the notification screen SC2 to the server 10 (Step S101). In a case in which the user terminal 20 communicates to and from the server 10, the server 10 can identify which user the request is from based on the transmission of the user ID or other data. When the server 10 receives the request to display the notification screen SC2 (Step S102), the server 10 refers to the user database DB1 and acquires a predetermined number of notifications received most recently by the user (Step S103). In Step S103, for example, 100 pieces of notification data are acquired in descending order of the date and time of the notifications from the current time.

The server 10 generates the display data of the notification screen SC2, and transmits the generated display data to the user terminal 20 (Step S104). In Step S104, the server 10 refers to the user database DB1, and acquires the setting data of the user. The server 10 generates display data including the setting data of the user and the 100 pieces of notification data acquired in Step S103. As described above, the display data includes scripts indicating the processing to be executed on the user terminal 20 side.

When the user terminal 20 receives the display data of the notification screen SC2 (Step S105), the user terminal 20 determines whether or not the notification satisfies the display condition associated with each of the plurality of display areas A20 (Step S106). In Step S106, the user terminal 20 executes a script included in the display data of the notification screen SC2, and determines, for each display area A20, whether or not each of the 100 notifications satisfies the display condition associated with the display area A20.

The user terminal 20 displays on the display unit 25, based on the determination results obtained in Step S106, a notification screen SC2 such that, in each of the plurality of display areas A20, the notifications determined to satisfy the display condition associated with the display area A20 are arranged (Step S107), and ends the processing. In Step S107, the user terminal 20 executes a script included in the display data of the notification screen SC2, and vertically arranges the notifications satisfying the display condition associated with the display area A20 in chronological order from top to bottom in each display area A20.

After the notification screen SC2 is displayed in the processing step of Step S107, processing corresponding to an operation by the user on the notification screen SC2 is executed. For example, when an operation to select a notification is performed, the user terminal 20 executes, together with the server 10, processing for displaying the thread screen SC1 of the message indicated by the notification. Then, for example, the user reacts to the message from the thread screen SC1, or performs the task requested by the message from a function other than the thread function.

For example, when an operation to read a past notification is performed, the user terminal 20 executes, together with the server 10, processing for displaying the past notification. In this case, the user terminal 20 requests a past notification of a display area A20 selected by the user. The server 10 refers to the user database DB1, and, of the notifications for which notification data has not been transmitted to the user terminal 20, acquires the notification data of a predetermined number of notifications in descending order from the current time. When the user terminal 20 receives the notification data, the user terminal 20 executes the same processing steps as those of Step S106 and Step S107, and displays the past notifications in the display area A20 satisfying the display condition.

For example, when an operation to change the display condition is performed, the user terminal 20 executes processing for changing the display condition together with the server 10. In this case, the server 10 stores the display condition changed by the user in the user database DB1. The user terminal 20 executes the same processing steps as those of Step S106 and Step S107 based on the changed display condition, and updates the display of the notification screen SC2. For example, when an operation to add a new display area A20 is performed, the user terminal 20 executes processing for adding a new display area A20 together with the server 10. In this case, the server updates the user database DB1 so that the new display condition designated by the user and the new display area A20 are associated with each other. The user terminal 20 arranges the notifications satisfying the new display condition in the new display area A20 associated with the new display condition. When an operation to close the notification screen SC2 is performed, the notification screen SC2 is closed.

The task support system 1 of the first embodiment determines whether or not a notification satisfies the display condition associated with each of the plurality of display areas A20 on the notification screen SC2. The task support system 1 displays the notification screen SC2 such that, in each of the plurality of display areas A20, the notifications determined to satisfy the display condition associated with the display area A20 are arranged. As a result, a notification that satisfies a certain display condition and a notification that satisfies another display condition can be confirmed on the same notification screen SC2, thereby increasing convenience for the user. For example, in the example of FIG. 3, after the to-me notification is designated as the display condition and displayed on the notification screen SC2, the user is not required to spend time and effort on switching the display of the notification screen SC2 with the timeline as the display condition, and those notifications can be simultaneously displayed on the notification screen SC2.

Further, the task support system 1 of the first embodiment displays a notification screen SC2 such that each of the plurality of display areas A20 is arranged in the horizontal direction, and the notifications determined to satisfy the display condition associated with the display area A20 are arranged in the vertical direction of each of the plurality of display areas A20. As a result, the visibility of the notification screen SC2 is increased. For example, by arranging the notifications in chronological order in the vertical direction of the display area A20, the chronological order of the notifications can be intuitively grasped.

Further, the task support system 1 of the first embodiment displays, in at least one display area A20 of the plurality of display areas A20, unread notifications determined to satisfy the display condition associated with the display area A20 and read notifications determined to satisfy the display condition associated with the display area A20 in such a manner that the unread notifications and the read notifications can be distinguished from each other. As a result, it is easier to distinguish between unread notifications and read notifications on the notification screen SC2.

Further, the task support system 1 of the first embodiment displays the notification screen SC2 for displaying notifications in the task support system 1 as information received by the user. As a result, user convenience in the task support system 1 is increased.

### 2. Second Embodiment

Next, a second embodiment of the present disclosure, which is another embodiment of the task support system 1, is described. For example, on the notification screen SC2, there may be notifications that do not require any operation by the user, and there may be notifications that require the user to perform some sort of operation in order to accomplish some sort of task. When the user checks on the notification screen SC2 a notification which requires some sort of operation to be performed, the user selects the notification to display the thread screen SC1. From the thread screen SC1, the user performs the task required of the user by reacting to the message or transitioning to another screen for performing the task relating to the message.

For example, the user may want to check other notifications after performing a task on the thread screen SC1 or another screen. In this case, it is required to return to the notification screen SC2 again from the thread screen SC1 or another screen. The user is required to go back and forth between the thread screen SC1 or another screen and the notification screen SC2, and hence it takes time and effort for the user to perform such operation. Thus, the second embodiment is configured such that it is possible to receive a simple operation such as a reaction to a notification displayed on the notification screen SC2.

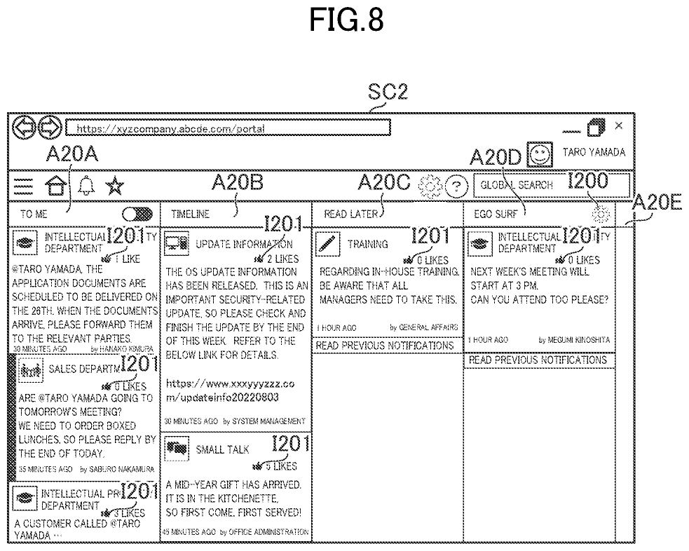

FIG. 8 is a view for illustrating an example of the notification screen SC2 in the second embodiment. As illustrated in FIG. 8, the overall layout of the notification screen SC2 is the same as in the first embodiment. In the second embodiment, an icon I201 for receiving a reaction to the message indicated by the notification is displayed in the display area A20. For example, when the user selects the icon I201 of a certain notification, the user can react to the message indicated by the notification while still displaying the notification screen SC2 without transitioning to the thread screen SC1.

As described above, in the second embodiment, a simple task can be performed on the notification screen SC2 by receiving an operation in relation to a notification displayed on the notification screen SC2. As a result, because the user can perform the task without going back and forth between the thread screen SC1 or another screen and the notification screen SC2, the time and effort of the user can be reduced. Details of the second embodiment are described below. In the second embodiment, description of configurations that are the same as in the first embodiment is omitted.

### 2-1. Functions Implemented in Second Embodiment

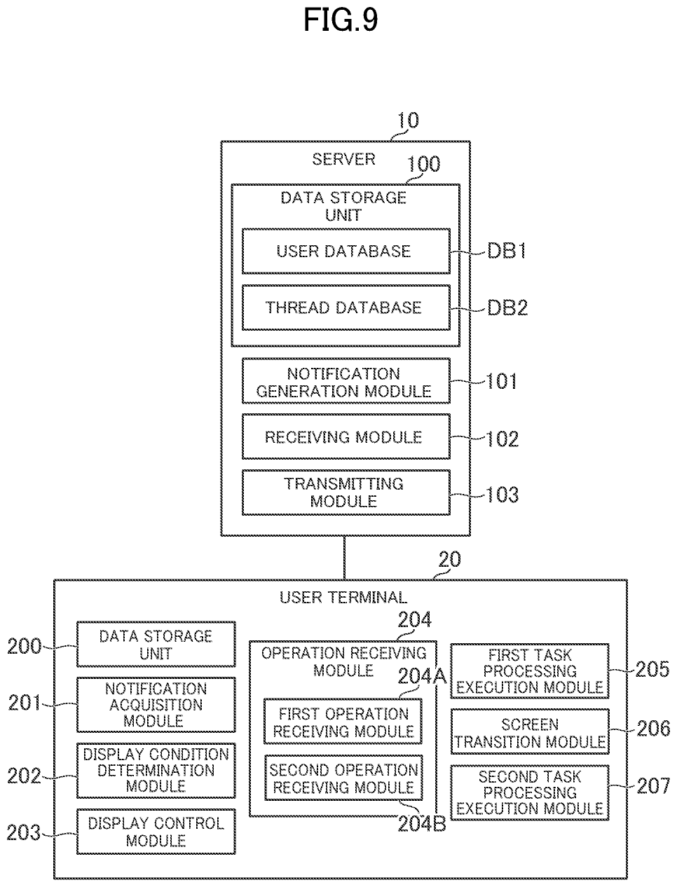

FIG. 9 is a diagram for illustrating an example of functions implemented in the second embodiment.

### 2-1-1. Functions Implemented by Server

The server 10 includes a data storage unit 100, a notification generation module 101, a receiving module 102, and a transmitting module 103. Each of those functions may be the same as in the first embodiment. However, in the second embodiment, the notification data includes the number of reactions to the message indicated by the notification, and the message data also includes the number of reactions to the message.

### 2-1-2. Functions Implemented by User Terminal

The user terminal 20 includes a data storage unit 200, a notification acquisition module 201, a display condition determination module 202, a display control module 203, an operation receiving module 204, a first task processing execution module 205, a screen transition module 206, and a second task processing execution module 207. The first task processing execution module 205, the screen transition module 206, and the second task processing execution module 207 are each implemented by the control unit 21.

[Data Storage Unit, Notification Acquisition Module, Display Condition Determination Module, and Display Control Module]

The functions of each of the data storage unit 200, the notification acquisition module 201, the display condition determination module 202, and the display control module 203 may be the same as in the first embodiment. Regarding the display control module 203 in the second embodiment, it suffices that the display control module 203 can display a notification screen SC2 relating to the notifications received by the user in the task support system 1, and the notification screen SC2 may be different from that of the first embodiment.

For example, in the second embodiment, the display control module 203 may display a notification screen SC2 which shows all the notifications received by the user without associating the notifications with the display condition for each display area A20. For example, the display control module 203 displays the notifications that satisfy a display condition designated by the user on the notification screen SC2, and when the user designates another display condition, the display control module 203 may switch the display of the notification screen SC2 such that the notifications that satisfy the another display condition are displayed. Thus, in the second embodiment, it is not required to implement the functions described in the first embodiment. The functions described in the second embodiment can be implemented without the functions described in the first embodiment.

[Operation Receiving Module]

The operation receiving module 204 may be similar to that in the first embodiment, but the operation receiving module 204 in the second embodiment includes a first operation receiving module 204A and a second operation receiving module 204B.

The first operation receiving module 204A receives a first operation relating to a notification-related task associated with the notification on the notification screen SC2. A notification-related task is some sort of task which is related to the notification. For example, the notification-related task is to register, change (update), or delete some sort of data relating to the notification. In the second embodiment, a case in which changing the message data of the message indicated by the notification corresponds to the notification-related task is described. Specifically, a case in which increasing the number of reactions included in the message data corresponds to the notification-related task is described.

The notification-related task may be any task, and is not limited to increasing the number of reactions. For example, replying to the message indicated by the notification may correspond to the notification-related task. For example, adding, changing, or deleting the database record indicated by the notification may correspond to the notification-related task. For example, changing some sort of status indicated by the notification or performing some sort of approval operation indicated by the notification may correspond to the notification-related task.

The first operation is an operation in relation to a notification displayed on the notification screen SC2. The first operation is an operation for performing a notification-related task. The first operation may be any operation that can be received on the notification screen SC2. For example, the first operation receiving module 204A receives, as the first operation, a reaction operation for making a reaction to a notification-related task. In the example of FIG. 8, the operation of selecting the icon I201 corresponds to the first operation. Thus, in the second embodiment, “operation of selecting the icon I201” can be read as “first operation.” The first operation may also be an operation of selecting a radio button or a check box, or an operation of selecting some other button.

A reaction is an action by another user to a message by a certain user. The reaction may be an action by the same user as the user who posted the message. For example, the reaction is a like or an emoji reaction. Inputting a reply to a message is also a kind of reaction. In the case in which inputting a reply to a message corresponds to the first operation, an input form for inputting the reply may be displayed in the notification on the notification screen SC2. For example, in a case in which a fixed phrase is input as the reply instead of inputting a free character string as the reply, an image for selecting the fixed phrase may be displayed in the notification. The reaction may also be made in relation to data other than a message.

The second operation receiving module 204B receives a second operation relating to the notification-related task on the thread screen SC1. The thread screen SC1 is an example of a transition destination screen. Thus, in the second embodiment, “thread screen SC1” can be read as “transition destination screen.” The transition destination screen may be any screen other than the notification screen SC2, and is not limited to the thread screen SC1. For example, a schedule sharing screen showing a schedule shared by the schedule sharing function, a file sharing screen showing a file shared by the file sharing function, and a database sharing screen showing a database shared by the database sharing function may correspond to the transition destination screen.

The second operation is an operation performed on the thread screen SC1. The second operation is an operation for performing a notification-related task. The second operation may be any operation that can be received on the thread screen SC1. For example, the second operation receiving module 204B receives, as the second operation, a reaction operation for reacting to the message displayed in the display area A10. In the example of FIG. 2, the operation of selecting the icon I100 in the display area A10 corresponds to the second operation. Thus, in the second embodiment, “operation of selecting the icon I100” can be read as “second operation.”

The second operation may be any operation for performing some sort of task, and is not limited to the icon I100. For example, the second operation may be an operation of selecting a radio button or a check box, or an operation of selecting some other button. For example, the second operation may be an operation of inputting a reply to the message displayed on the thread screen SC1. For example, the second operation may be an operation of inputting some sort of comment, an operation of uploading some sort of file, an operation of adding, changing, or deleting a database record, or an operation of performing some sort of approval.

[First Task Processing Execution Module]

The first task processing execution module 205 executes, based on the first operation, first task processing relating to the notification-related task. In the second embodiment, the first task processing execution module 205 is included in the user terminal 20, and hence the first task processing is processing for transmitting to the server 10 a request to register, change, or delete data relating to the notification-related task. The server 10 registers, changes, or deletes the target data based on the request.

For example, the first task processing execution module 205 executes, based on the reaction operation, reaction processing relating to the reaction as the first task processing. For example, the first task processing is processing for requesting a change in reaction information associated with a message. For example, when the user selects the icon I201 for a message notification for which no reaction has been made, processing for requesting an increase in the number of reactions associated with the message corresponds to the first task processing. When the user selects the icon I201 for a message notification for which a reaction has been made, processing for requesting cancellation of the reaction to the message corresponds to the first task processing.

For example, in the second embodiment, the operation of selecting the icon I201 corresponds to the first operation, and the operation of selecting the icon I100 corresponds to the second operation. Thus, the first operation and the second operation are operations received on different screens, but are the same in terms of each being an operation for increasing the number of reactions. When processing other than processing for increasing the number of reactions is executed as the notification-related task, the first operation that can be received on the notification screen SC2 may be the same as the second operation that can be received on the thread screen SC1 or may be a simpler operation than the second operation. The notification screen SC2 may receive a second operation that is exactly the same as the first operation received on the thread screen SC1.

As used herein, a simple operation means an operation that requires a small number of operations in order to obtain a certain result. For example, in a case in which changing some sort of status on the notification screen SC2 corresponds to the notification-related task, for the first operation on the notification screen SC2, only one operation may be required, such as selecting a button on the notification, but in order to change the same status on the thread screen SC1, two or more operations may be required as the second operation, including an operation for displaying the status and an operation for changing the status.

As another example, in a case in which a reply to the message corresponds to the notification-related task, for the first operation on the notification screen SC2, the reply can be performed by selecting a fixed phrase, but in order to perform a reply on the thread screen SC1, two or more operations may be required as the second operation, including an operation of selecting an icon indicating an intention to reply and an operation of inputting the text of the reply. In other notification-related tasks as well, the first operation may similarly be simpler than the second operation.

The second operation received from the thread screen SC1 can perform a more detailed notification-related task. For example, when replying to a message, it is possible to input free text instead of a fixed phrase in the second operation. For example, when the operation is for changing the status, there may be more types of status that can be designated from the thread screen SC1 than the types of status that can be designated from the notification screen SC2.

[Screen Transition Module]

When a notification is selected on the notification screen SC2, the screen transition module 206 transitions the screen to the thread screen SC1 associated with the notification. The thread screen SC1 associated with the notification is the screen of the transition destination to be transitioned to by selecting the notification. The flow of transitioning to the thread screen SC1 is as described in the first embodiment. In the second embodiment, the screen transition module 206 is implemented by the user terminal 20, and hence the screen transition module 206 transitions the screen to the thread screen SC1 by transmitting a request to display the thread screen SC1 to the server 10.

The notification ID of the selected notification is included in the request to display the thread screen SC1. In the thread database DB2, the message IDs and the notification IDs are associated with each other, and hence the server 10 can identify which message should be displayed on the thread screen SC1 based on the notification ID included in the display request. The server 10 generates the display data of the thread screen SC1 including this message and transmits the generated display data to the user terminal 20. When the user terminal 20 receives the display data of the thread screen SC1, the screen transition module 206 displays the thread screen SC1 on the display unit 25 based on the received display data.

[Second Task Processing Execution Module]

The second task processing execution module 207 executes second task processing relating to the notification-related task based on the second operation. In the second embodiment, the second task processing execution module 207 is included in the user terminal 20, and hence the second task processing is processing for requesting the server 10 to register, change, or delete data relating to the notification-related task. The server 10 registers, changes, or deletes the target data based on the request.

The second task processing is different from the first task processing in that the processing is performed from the thread screen SC1, but is otherwise the same. Thus, similarly to the first task processing, the second task processing can be any processing, such as processing for increasing the number of reactions, processing for replying to a message, processing for changing a status, or processing for changing a database. The second task processing execution module 207 executes those processes based on the second operation on the thread screen SC1.

### 2-2. Processing to be Executed in Second Embodiment

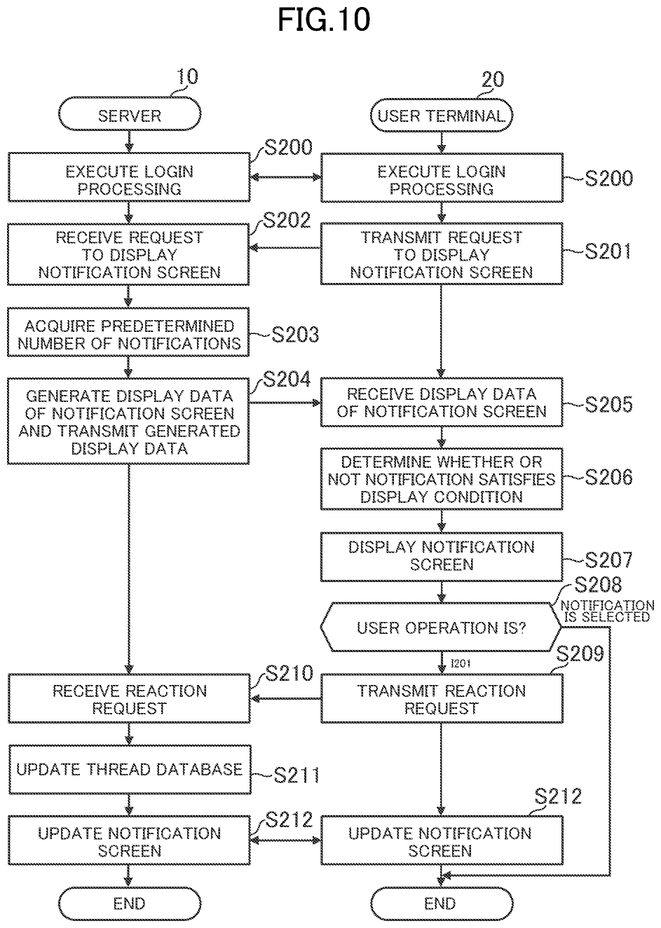

FIG. 10 is a diagram for illustrating an example of processing to be executed in the second embodiment. The processing steps of Step S200 to Step S207 of FIG. 10 are the same as the processing steps of Step S100 to Step S107 of FIG. 7. In Step S207, when the notification screen SC2 is displayed, the user terminal 20 determines whether or not the icon I201 has been selected or the notification in the display area A20 has been selected (Step S208).

When it is determined in Step S208 that the icon I201 has been selected (“I201” in Step S208), the user terminal 20 transmits a reaction request to the server 10 (Step S209). When the server 10 receives the reaction request (Step S210), the server 10 updates the thread database DB2 (Step S211), executes processing for updating the notification screen SC2 together with the user terminal 20 (Step S212), and ends this processing.

When it is determined in Step S208 that the notification in the display area A20 has been selected (“notification is selected” in Step S208), this processing ends. In this case, the user terminal 20 executes, together with the server 10, processing for displaying the thread screen SC1. Processing for performing the task relating to the message is executed between the server 10 and the user terminal 20.

The task support system 1 of the second embodiment executes first task processing based on the first operation received on the notification screen SC2. As a result, the notification can be checked on the notification screen SC2 and a simple task can be directly performed, and hence the time and effort spent by the user can be reduced. For example, after transitioning from the notification screen SC2 to the thread screen SC1 and performing a reaction operation, the user is no longer required to return to the notification screen SC2 again. From the notification screen SC2, the user can perform a reaction operation to a message indicated by a certain notification, and then check other notifications on the same screen. As a result, the task efficiency of the user is increased.

Further, in the task support system 1 of the second embodiment, the first operation that can be received on the notification screen SC2 is the same as, or simpler than, the second operation that can be received on the thread screen SC1 to which the notification screen SC2 transitions when a notification is selected on the notification screen SC2. When the first operation and the second operation are the same, the same operation as the task performed from the thread screen SC1 can be received on the notification screen SC2. When a complex operation is to be performed on the notification screen SC2, such an operation may take up more of the display space of the notification screen SC2 because of that complexity. However, when the first operation is a simple operation that can be performed on the notification screen SC2, it is possible to prevent such an operation from taking up much of the display space of the notification screen SC2.

Further, the task support system 1 of the second embodiment executes reaction processing based on the reaction operation received on the notification screen SC2. As a result, the notification can be checked on the notification screen SC2 and the reaction can be made on the same screen. Thus, the user can be saved from the time and effort of transitioning from the notification screen SC2 to the thread screen SC1 in order to make the reaction.

### 3. Modification Examples

The present disclosure is not limited to the examples of the first embodiment and the second embodiment described above, and can be modified suitably without departing from the spirit of the present disclosure.

### 3-1. Modification Examples Relating to First Embodiment

First, modification examples relating to the first embodiment are described.

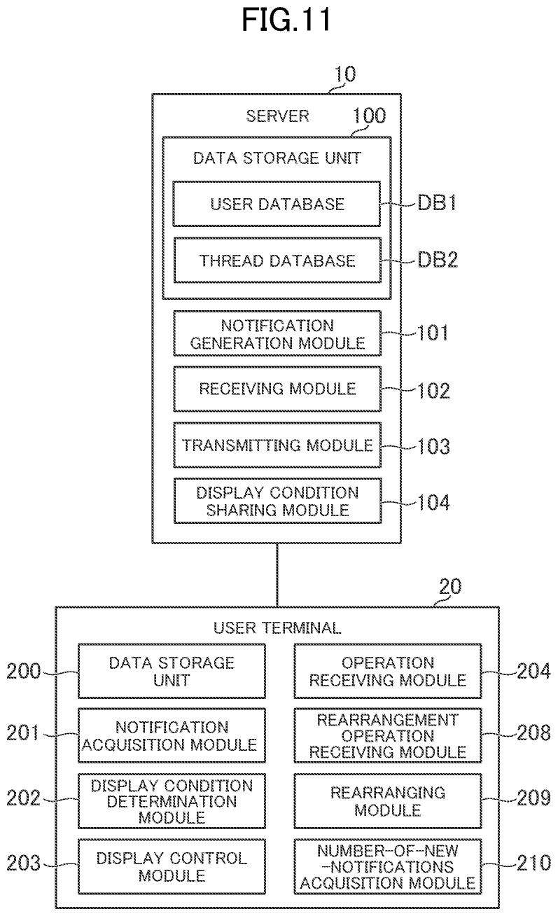

FIG. 11 is a diagram for illustrating an example of functions implemented in the modification examples relating to the first embodiment. For example, the server 10 includes a display condition sharing module 104. The display condition sharing module 104 is implemented by the control unit 11. For example, the user terminal 20 includes a rearrangement operation receiving module 208, a rearranging module 209, and a number-of-new-notifications acquisition module 210. The rearrangement operation receiving module 208, the rearranging module 209, and the number-of-new-notifications acquisition module 210 are each implemented by the control unit 11.

### Modification Example 1-1

For example, in the first embodiment, a case in which the notifications in a certain one task support system 1 are displayed on the notification screen SC2 has been described. However, the notifications of each of a plurality of task support systems 1 may be displayed on one notification screen SC2. In Modification Example 1-1, a case in which the notifications of each of three task support systems 1, that is, groupware A, groupware B, and groupware C, are displayed on one notification screen SC2 is described as an example. However, the notifications of each of two or each of four or more task support systems 1 may be displayed.

The notification acquisition module 201 in Modification Example 1-1 acquires the notifications of each of the plurality of task support systems 1 used by the user. In Modification Example 1-1, there are a plurality of task support systems 1 having the same configuration as the hardware illustrated in FIG. 1. Each of the plurality of task support systems 1 are connected to each other via a network N so as to be able to communicate to and from each other. The functions implemented by each of the plurality of task support systems 1 may be the same as the functions described in the first embodiment, or there may be a task support system 1 that does not have the functions described in the first embodiment.

In Modification Example 1-1, each of the plurality of task support systems 1 cooperates with each other. In Modification Example 1-1, each of the plurality of task support systems 1 shares the user IDs and notification data with each other. Thus, each of the plurality of task support systems 1 can mutually grasp which user has received which notification. The data formats of the notification data are assumed to be the same, but the data formats may be different. When the data formats of the notification data are different, each of the plurality of task support systems 1 shares the data formats of the notification data with each other.

The notification acquisition module 201 of the user terminal 20 may acquire the notifications by communicating to and from each of the plurality of task support systems 1, or may use the task support system 1 the user is logged into to acquire the notifications from the remaining task support systems 1. As another example, the user database DB1 of a certain task support system 1 may manage the notifications in the other task support systems as well. In this case, the notification acquisition module 201 acquires, from the certain task support system 1, the notifications of each of all the task support systems 1.

The display control module 203 in Modification Example 1-1 displays the notification screen SC2 such that, in each of the plurality of display areas A20, the notifications of each of the plurality of task support systems 1 determined to satisfy the display condition associated with the display area A20 are arranged. This differs from the first embodiment in the point that the notifications of each of the plurality of task support systems 1 are displayed on the notification screen SC2, but the processing for determining whether or not the notifications satisfy the display condition and the processing for displaying the notification screen SC2 based on the processing results are as described in the first embodiment.

In the example of the notification screen SC2 of FIG. 3, in a case in which the user is using all of groupware A to groupware C, the display control module 203 displays the to-me notifications received from groupware A, the to-me notifications received from groupware B, and the to-me notifications received from groupware C in a mixed manner in the display area A20A. Similarly, for the display areas A20B to A20E, the display control module 203 displays the notifications received from each of groupware A to groupware C and satisfying the display condition associated with each of the display areas A20B to A20E in a mixed manner.

The task support system 1 of Modification Example 1-1 displays the notification screen SC2 such that, in each of the plurality of display areas A20, the notifications of each of the plurality of task support systems 1 determined to satisfy the display condition associated with the display area A20 are arranged. As a result, the notifications of each of the plurality of task support systems 1 can be displayed together on one notification screen SC2, thereby increasing the convenience of the user.

### Modification Example 1-2

For example, the task support system 1 provides users with a plurality of functions relating to task support, such as a thread function, a schedule sharing function, a file sharing function, and a database sharing function. In this case, the plurality of display areas A20 may include display areas A20 associated with display conditions relating to a plurality of functions. That is, the display condition may include a condition relating to a certain first function and a condition relating to a second function different from the first function. In Modification Example 1-2, a thread function and a database sharing function are described as examples of the plurality of functions.

On the thread screen SC1 of FIG. 2, “App” is an example of the database sharing function. In the example of FIG. 2, an invoice management app sharing an invoice database, a patent management app sharing a patent application database, a design management app sharing a design application database, and a trademark management app sharing a trademark application database are used. Those apps are used by the user to share the various kinds of information stored in the databases. The user receives a notification when, for example, an app record is added, changed, or deleted. The user also receives a notification when a comment is input in an app.

For example, in at least one of the plurality of display areas A20, the condition relating to each of the plurality of functions is defined by “OR,” such as “intellectual property department thread notification or invoice management app notification.” The condition may be defined by “AND” instead of “OR.” As another example, when the display condition includes three or more conditions, the display condition may be defined by using both “OR” and “AND.” The display condition may include conditions relating to three or more functions, such as “intellectual property department thread notification, invoice management app notification, or design management app notification.”

The display condition determination module 202 in Modification Example 1-2 determines whether or not the notification satisfies each of the plurality of conditions included in the display condition for the display areas A20 associated with the display condition for a plurality of functions. For example, for the display condition including the two conditions “intellectual property department thread notification or invoice management app notification,” the display condition determination module 202 determines whether or not the notification satisfies the display condition by determining whether or not the cause of the notification is the intellectual property department thread or the invoice management app. The processing by which the display control module 203 displays the notification screen SC2 based on the determination result of the display condition determination module 202 is as described in the first embodiment.

The task support system 1 of Modification Example 1-2 provides the user with a plurality of functions relating to task support, and the plurality of display areas A20 include display areas A20 associated with display conditions relating to a plurality of functions. As a result, display conditions which are more flexible can be associated with the display areas A20, thereby increasing the convenience of the user.

### Modification Example 1-3

For example, in the example of FIG. 3, a case in which the display conditions for the display areas A20A to A20C are determined in advance on the task support system 1 side, and the display conditions for the display areas A20D and A20E can be freely designated by the user is illustrated. Thus, in the example of FIG. 3, the plurality of display areas A20 include display areas A20 associated with display conditions designated by the user. For example, the plurality of display areas A20 may include only display areas A20 associated with display conditions designated by the user. In Modification Example 1-3, the display conditions designated by the user are shared with another user.

The task support system 1 of Modification Example 1-3 includes the display condition sharing module 104. The display condition sharing module 104 shares the display conditions designated by the user with another user. For example, the display condition sharing module 104 enables another user to view the display conditions designated by the user. In the example described in the first embodiment, when another user “Hanako Kimura” requests display of the display conditions designated by the user “Taro Yamada,” the display condition sharing module 104 displays the display conditions designated by the user “Taro Yamada” on the user terminal 20 of the another user “Hanako Kimura.”

The sharing of the display conditions may be performed by any method, and is not limited to simple viewing. For example, the display condition sharing module 104 may share the display conditions designated by the user “Taro Yamada” by copying the designated display conditions as the display conditions for another user “Hanako Kimura.” The display condition sharing module 104 may share the display conditions designated by the user “Taro Yamada” by transmitting those designated display conditions to the email address of the another user “Hanako Kimura.”

The task support system 1 of Modification Example 1-3 shares the display conditions designated by a user with another user. There is a possibility that a display condition designated by a certain user becomes a reference for another user, and hence by sharing the display conditions among the users, the convenience of the users is increased.

### Modification Example 1-4

For example, in the example of FIG. 3, a case in which the positions of the display areas A20A to A20C of the first to third columns from the left of the notification screen SC2 are fixed, and the display areas A20D and A20E of the fourth and subsequent columns are arranged in order of date and time of creation is illustrated. The order of the display areas A20 on the notification screen SC2 may be freely designated by the user. The task support system 1 of Modification Example 1-4 includes the rearrangement operation receiving module 208 and the rearranging module 209.

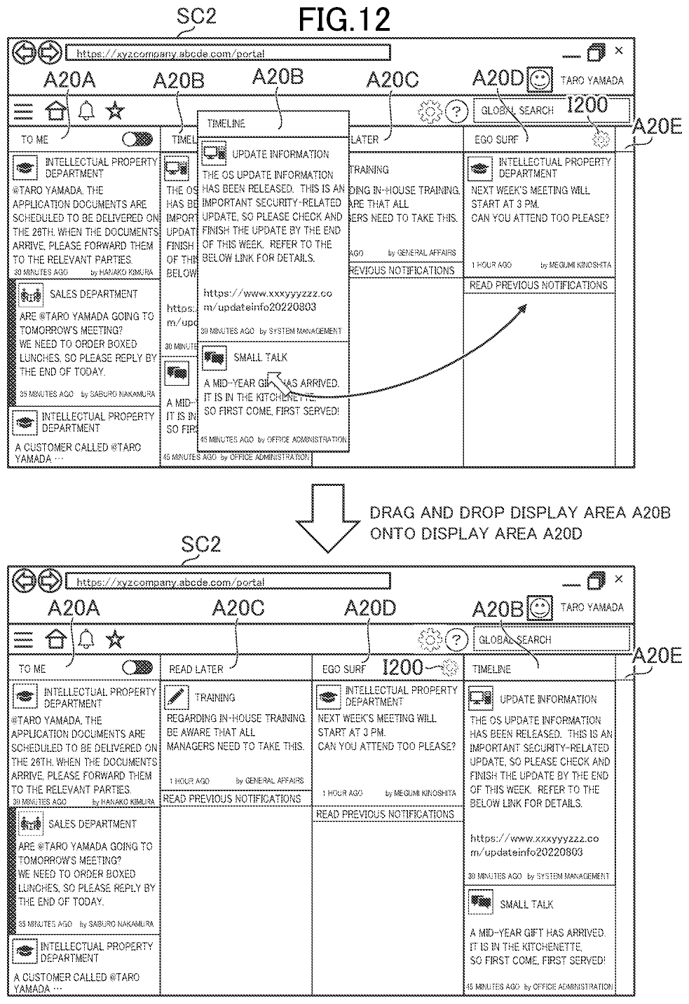

FIG. 12 is a view for illustrating an example of rearrangement of the display area A20 performed on the notification screen SC2. For example, the rearrangement operation receiving module 208 receives a rearrangement operation relating to rearranging all or a part of the plurality of display areas A20 on the notification screen SC2. As used herein, “rearrangement” refers to changing the order of the display area A20 on the notification screen SC2. In Modification Example 1-4, a case in which the rearrangement operation is drag and drop is described, but the rearrangement operation is not limited to drag and drop as long as the rearrangement operation is a predetermined operation. For example, an operation of selecting a button such as an arrow for instructing rearrangement or an operation of inputting a numerical value indicating an order in an input form may correspond to the rearrangement operation.

In the example of FIG. 12, the operation of dragging and dropping the display area A20B onto the display area A20D as illustrated in the upper notification screen SC2 corresponds to the rearrangement operation. The rearranging module 209 rearranges all or a part of the plurality of display areas A20 based on the rearrangement operation. In the example of FIG. 12, the rearranging module 209 performs the rearrangement such that the order of the display area A20B comes after the display area A20D. Thus, as illustrated in the lower notification screen SC2 of FIG. 12, the order becomes the display areas A20A, A20C, A20D, A20B, and A20E.

It suffices that the rearranging module 209 performs the rearrangement corresponding to the rearrangement operation. For example, in the example of FIG. 12, the rearranging module 209 may perform the rearrangement such that the order of the display areas A20B and A20D is switched without changing the order of the display area A20C sandwiched between the display areas A20B and A20D. In this case, as a result of the rearrangement, the order becomes the display areas A20A, A20D, A20C, A20B, and A20E. As another example, in the example of FIG. 12, the rearranging module 209 may perform the rearrangement such that the order of the display area A20B comes before the display area A20D. In this case, as a result of the rearrangement, the order becomes the display areas A20A, A20C, A20B, A20D, and A20E.

The task support system 1 of Modification Example 1-4 rearranges all or a part of the plurality of display areas A20 on the notification screen SC2 based on the rearrangement operation. As a result, the order of the display areas A20 can be set to the order suited to a preference of the user based on a simple operation, thereby increasing the convenience of the user.

### Modification Example 1-5

For example, when the number of display areas A20 included in the notification screen SC2 increases, it may not be possible to display all of the display areas A20 at once, and hence the user is required to scroll the notification screen SC2. In this case, it may take time and effort for the user to display the desired display area A20. Thus, an index area in which icons for moving to one of the plurality of display areas A20 are arranged may be displayed on the notification screen SC2.

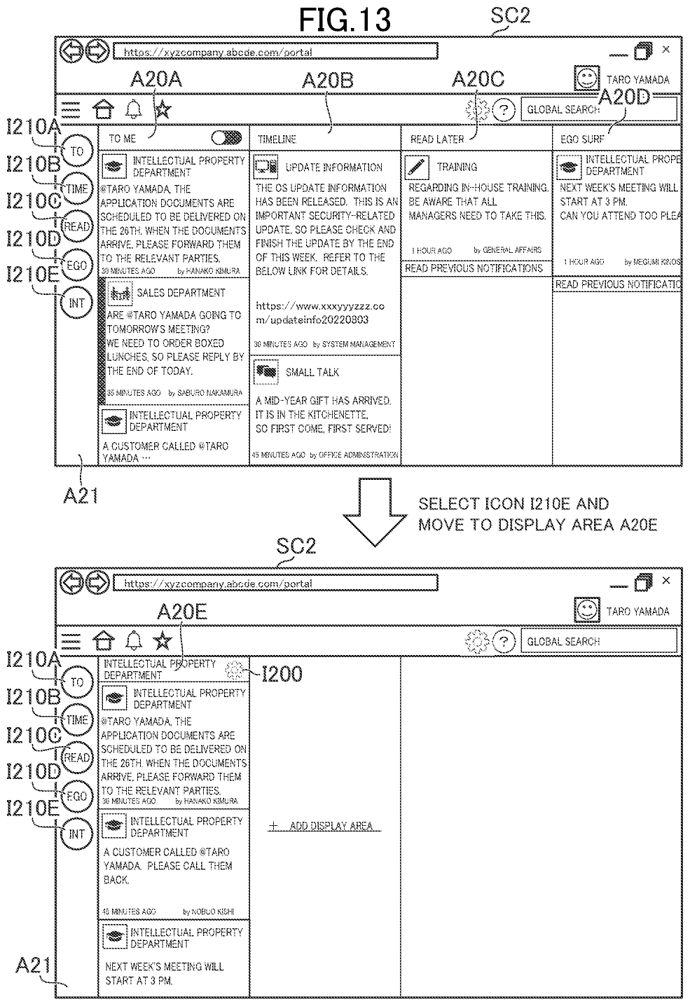

FIG. 13 is a view for illustrating an example of the notification screen SC2 in Modification Example 1-5. The display control module 203 in Modification Example 1-5 displays a notification screen SC2 including an index area A21 relating to an index of a plurality of display areas A20. For example, the display control module 203 displays icons I210A to I210E corresponding to the plurality of display areas A20 in the index area A21. In the following description, when the icons I210A to I210E are not distinguished, those icons are simply be referred to as “icons I210.” The icons I210 correspond the display areas A20 on a one-to-one basis.

In the example of FIG. 13, the index area A21 is arranged on the left side of the display areas A20, but the positional relationship between the display areas A20 and the index area A21 may be any positional relationship, and is not limited to the example of FIG. 13. For example, the index area A21 may be arranged above, to the right of, or below the display areas A20. In Modification Example 1-5, a case in which the display position of the index area A21 does not change even when the display areas A20 are scrolled is described, but the index area A21 may be scrolled together with the display areas A20.

The display control module 203 in Modification Example 1-controls, when one of the plurality of display areas A20 is selected in the index area A21, the display relating to the selected display area A20. For example, the display control module 203 controls the display of the notification screen SC2 so as to move to the selected display area A20. For example, each of the plurality of icons I210 is associated with the position of the display area A20 to be displayed when the icon I210 is selected. The display control module 203 controls the notification screen SC2 so as to move to the position associated with the selected icon I210 when any one of the plurality of icons I210 is selected.

When the user selects the icon I210E in the index area A21 on the upper notification screen SC2 of FIG. 13, the display control module 203 identifies the position of the display area A20E associated with the icon I210E. As illustrated in the lower notification screen SC2 of FIG. 13, the display control module 203 moves to the identified position and displays the display area A20E on the notification screen SC2. Those processing steps are executed by a script included in the display data of the notification screen SC2. A publicly known command may be used as the script command for changing the display position.

The display control module 203 may control some of the display relating to the selected icon I210 when any one of the plurality of icons I210 is selected in the index area A21. This display control is not limited to the above-mentioned moving to the display area A20. For example, the display control module 203 may display the display area A20 in a highlighted manner when the display area A20 corresponding to the icon I210 selected by the user is already displayed. The highlighting may be performed in any manner. For example, the highlighting may be performed by changing a background color or a character color of the display area A20, or by enlarging the display area A20.

As another example, the display control module 203 may control the display of the display area A20 corresponding to the icon I210 selected by the user so that the display area A20 moves into the notification screen SC2. In this case, the display area A20 may be arranged on the leftmost side of the notification screen SC2. For example, the display control module 203 may control the display of the display area A20 corresponding to the icon I210 selected by the user so that only that display area A20 is displayed on the notification screen SC2.

The task support system 1 of Modification Example 1-5 controls, when any one of the plurality of display areas A20 is selected in the index area A21, the display relating to the selected display area A20. As a result, for example, the user is not required to perform scrolling in order to display a display area A20 that was not able to be displayed on the notification screen SC2, thereby increasing the convenience of the user. For example, when the display area A20 corresponding to the icon I210 selected by the user is displayed in a highlighted manner, the user can notice the display area A20 more easily. For example, when the display area A20 corresponding to the icon I210 selected by the user moves, the user is not required to perform scrolling in order to display the display area A20. For example, when only the display area A20 corresponding to the icon I210 selected by the user is displayed, the user is not required to perform scrolling in order to display the display area A20, and the display area A20 can be displayed in an easy-to-see state.

### Modification Example 1-6

For example, when the index area A21 is displayed as in Modification Example 1-5, the number of new notifications may be displayed in association with the icons I210. The notification data in Modification Example 1-6 may include a new notification flag. The new notification flag is turned on when notification data is generated, and is turned off after the notification data is transmitted to the user terminal 20. The number of new notifications may also be counted using the unread/read flag without using the new notification flag. In this case, the number of new notifications is the total number of unread notifications.

The task support system 1 of Modification Example 1-6 includes the number-of-new-notifications acquisition module 210. The number-of-new-notifications acquisition module 210 acquires the number of new notifications relating to the information satisfying the display condition associated with each of the plurality of display areas A20. In Modification Example 1-6, the new notification flag is included in the notification data, and hence the number-of-new-notifications acquisition module 210 acquires the number of new notifications by referring to, for each display area A20, the new notification flag of the notifications that satisfy the display condition associated with the display area A20, and counting the number of notifications in which the new notification flag is on.

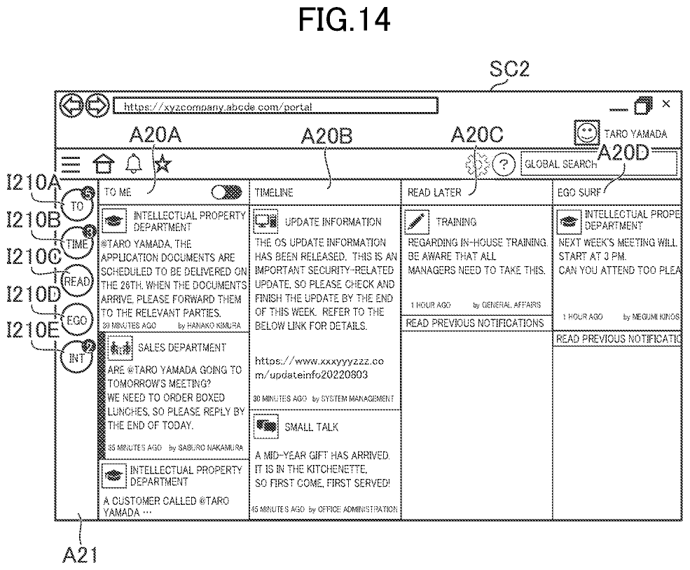

FIG. 14 is a view for illustrating an example of the notification screen SC2 in Modification Example 1-6. The display control module 203 in Modification Example 1-6 displays each of the plurality of display areas A20 and the numbers of new notifications of those display areas A20 in association with each other in the index area A21. For example, the display control module 203 displays the number of new notifications on a badge of the icons I210. Any method may be used to display the number of new notifications, and the method is not limited to badges. For example, the number of new notifications may be displayed on an icon different from the icon I210, or the number of new notifications may be displayed by arranging a character string indicating the number of new notifications near the icon I210.

The task support system 1 of Modification Example 1-6 displays each of the plurality of display areas A20 and the numbers of new notifications of those display areas A20 in association with each other in the index area A21. As a result, the number of new notifications of each of the plurality of display areas A20 can be checked in the index area A21, thereby increasing the convenience of the user.

### Modification Example 1-7

For example, in the first embodiment, a case in which the display condition determination module 202 is included in the user terminal 20 has been described, but the display condition determination module 202 may be included in the server 10. In this case, similarly to the first embodiment, the display condition determination module 202 of the server 10 may execute the determination processing each time a request to display the notification screen SC2 is received, or may execute the determination processing in advance and store the determination result in the user database DB1.

The display condition determination module 202 in Modification Example 1-7 is included in the server 10. The display condition determination module 202 of the server 10 determines, before the request to display the notification screen SC2 is received, whether or not the notification satisfies the display condition associated with each of the plurality of display areas A20, and holds the determination result. As used herein, “hold” refers to recording the determination result in the data storage unit 100. In Modification Example 1-7, a case in which the determination result is stored in the user database DB1 is described, but the determination result may be stored in another database. The determination processing itself of the display condition determination module 202 is different in that the processing is executed on the server 10 side, but the content of the processing is as described in the first embodiment.

The display control module 203 in Modification Example 1-7 displays the notification screen SC2 based on the held determination result. For example, when the display control module 203 is included in the server 10, the display control module 203 of the server 10 generates the display data of the notification screen SC2 by identifying, for each display area A20, the notifications satisfying the display condition associated with the display area A20 based on the held determination result, and arranging the identified notifications.

The task support system 1 of Modification Example 1-7 determines, before the request to display the notification screen SC2 is received, whether or not the information satisfies the display condition associated with each of the plurality of display areas A20, and holds the determination result. The task support system 1 displays the notification screen SC2 based on the held determination result. As a result, the determination processing can be completed in advance, and hence the processing for displaying the notification screen SC2 can be speeded up. Further, in a case in which the server 10 executes the determination processing when a request to display the notification screen SC2 is received, the processing load on the server 10 may increase when a large number of display requests overlap. However, by executing the determination processing in advance, the processing load on the server 10 can be reduced.

### Modification Example 1-8

For example, the display condition determination module 202 may determine, when a new display condition is added, whether or not the notifications satisfy the new display condition by going back to the notifications received by the user in the past. Modification Example 1-8 differs from the first embodiment in that the notifications to be determined are past notifications, but the determination method itself of the display condition determination module 202 is as described in the first embodiment.

When a new display condition is added, the display control module 203 in Modification Example 1-8 adds a new display area A20 in which notifications determined to satisfy the new display condition are arranged on the notification screen SC2. Modification Example 1-8 differs from the first embodiment in that the notifications to be determined are past notifications, but the display itself of the notification screen SC2 is as described in the first embodiment.

When a new display condition is added, the task support system 1 of Modification Example 1-8 goes back to notifications received by the user in the past to determine whether or not the new display condition is satisfied. As a result, even when a new display condition is added, past notifications satisfying the new display condition can be displayed in the new display area A20.

### Other Modification Examples Relating to First Embodiment

For example, the functions described as being implemented by the user terminal 20 may be implemented by the server 10. The notification acquisition module 201, the display condition determination module 202, and the display control module 203 may be implemented by the server 10 instead of by the user terminal 20. In this case, the notification acquisition module 201 of the server 10 acquires the notifications by referring to the user database DB1 and acquiring a predetermined number of pieces of notification data. The display condition determination module 202 of the server 10 refers to the user database DB1 to identify the display conditions associated with the display areas A20, and determines whether or not each of the notifications satisfies the display condition. The display control module 203 of the server 10 generates the display data of the notification screen SC2 in which the notifications are arranged in the display areas A20 based on the determination result, and transmits the generated display data to the user terminal 20. The user terminal 20 displays the notification screen SC2 on the display unit 25 when the display data is received.

For example, a case in which the display control system is applied to the task support system 1 has been described as an example, but the display control system can also be applied to screens other than screens for task support. For example, the display control system can be applied to an email software screen. When the display control system is applied to email software, a preview area of the email received by the user corresponds to the display area, and a preview displayed in the preview area corresponds to the notification. As another example, the display control system may be applied to a screen displaying notifications on an OS or a screen displaying notifications on some sort of software used by the user.

### 3-2. Modification Examples Relating to Second Embodiment

Next, modification examples relating to the second embodiment are described.

### Modification Example 2-1

For example, in the second embodiment, there has been described a case in which, when a notification on the notification screen SC2 is selected, the notification screen SC2 is erased and the screen transitions to the thread screen SC1 of the thread in which the message indicated by the notification is posted. From the thread screen SC1 of the transition destination, the user performs a notification-related task by reacting to the message indicated by the notification or changing the database record relating to the message. In this case, when the user finishes the notification-related task and returns to the notification screen SC2, the display of the notification screen SC2 is updated, and hence there is a possibility that the arrangement of the notifications on the notification screen SC2 changes.

Thus, the screen transition module 206 in Modification Example 2-1 displays the thread screen SC1 as a pop-up of the notification screen SC2 or as a tab separate from the notification screen SC2. The display of the notification screen SC2 is maintained even when the thread screen SC1 is displayed. Maintaining the display of the notification screen SC2 means that the content of the notification screen SC2 does not change. For example, on the notification screen SC2 of FIG. 3, when the topmost notification of the display area A20A is selected, the thread screen SC1 of FIG. 2 is displayed as a pop-up or a separate tab. The display of the window or tab corresponding to the notification screen SC2 does not change.

The task support system 1 of Modification Example 2-1 displays the thread screen SC1 as a pop-up of the notification screen SC2 or as a tab separate from the notification screen SC2. The display of the notification screen SC2 is maintained even when the thread screen SC1 is displayed. When the user returns to the notification screen SC2 after displaying the thread screen SC1, in some cases, the arrangement of the notifications on the notification screen SC2 may change, for example, the notifications that have been read may not be displayed, or the display positions of the notifications may change due to the arrival of new notifications. In such a case, even when the user has visually memorized the arrangement of the notifications, the arrangement of the notifications may change when the user returns to the notification screen SC2, and the user may lose sight of the notifications which he or she wishes to check. In this regard, with the configuration of Modification Example 2-1, the display of the notification screen SC2 is maintained and the arrangement of the notifications does not change, and hence the convenience of the user is increased.

### Modification Example 2-2

For example, in the second embodiment, a reaction operation is described as an example of the first operation, but the first operation may be any operation for performing a notification-related task on the notification screen SC2, and is not limited to a reaction operation. Description is now given of a case in which the first operation receiving module 204A in Modification Example 2-2 receives a status change operation for changing a status of a notification-related task as the first operation. In Modification Example 2-2, it is assumed that the status relating to a task is stored in the thread database DB2 or another database.

In Modification Example 2-2, as an example of the status, a workflow in which a task is completed by sequentially performing a plurality of predetermined procedures is described. For example, in a case of a task relating to a patent application, a workflow including procedures, such as holding a preparatory meeting, receiving a manuscript, notifying results of a check of the manuscript, instructing that the application is to be filed, and reporting on the completion of the application, is executed. For example, when the task relates to in-house training, a workflow including procedures, such as applying for the training, receiving training materials, and submitting a report, is executed. The status is information indicating which of those procedures is being executed.

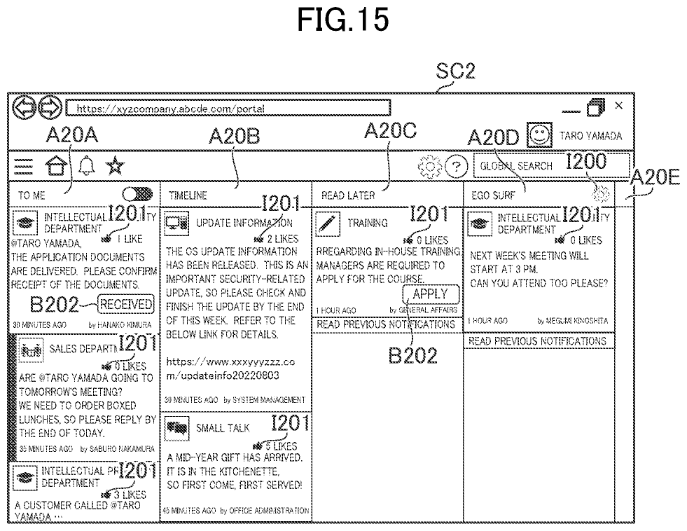

FIG. 15 is a view for illustrating an example of the notification screen SC2 in Modification Example 2-2. For example, the display control module 203 determines whether or not the notification is requesting the user who is displaying the notification screen SC2 to change some sort of status. For notifications relating to a workflow, the task support system 1 of Modification Example 2-2 is being requested to change a status. Thus, the display control module 203 determines whether or not the notification is requesting the user to change a status by determining whether or not the notification relates to a workflow. It is assumed that information indicating whether or not the notification relates to a workflow is included in the notification data.

When it is determined that the notification is requesting a status change, the display control module 203 displays a button B202 for receiving a change to a status in the notification. The button B202 includes a command for instructing a change to a status. In the example of FIG. 15, the notification at the top of the display area A20A displays a button B202 for changing a status indicating whether or not a manuscript has been received. The notification in the display area A20C displays a button B202 for changing a status indicating whether or not a student has applied for a course.

The image for receiving the status change may be any image and is not limited to the button B202. For example, the status change may be received by using a check box, or the status change may be received by using a pop-up. In Modification Example 2-2, a case in which the operation of selecting the button B201 corresponds to the status change operation is described, but an operation performed on another image such as a check box may correspond to the status change operation.

The method of determining whether or not the notification is requesting a status change may be any method, and is not limited to the above-mentioned example. For example, the display control module 203 may determine whether or not the notification is requesting a status change by determining whether or not a character string (for example, a character string such as “approved”) indicating that a status change is requested is included in the main text of the notification. For example, when the user who posted the message performs a specific operation for requesting a status change, information indicating that such an operation has been performed is included in the notification data, and the display control module 203 determines whether or not the notification is requesting a status change by referring to the information.

The first task processing execution module 205 in Modification Example 2-2 executes status change processing relating to the status change as first task processing based on the status change operation. For example, the first task processing execution module 205 transmits a status change request including information that can identify the status indicated by the status change operation to the server 10. When the server 10 receives the status change request, the server 10 changes the status stored in the thread database DB2 or another database.

The task support system 1 of Modification Example 2-2 executes the status change processing relating to the status change as the first task processing based on the status change operation. As a result, the status relating to the task of a user can be changed without transitioning from the notification screen SC2 to another screen, thereby reducing the time and effort of the user.

### Modification Example 2-3

For example, the first operation may be any operation, and is not limited to the operation of selecting the icon I201 or the button B202. The first operation receiving module 204A in Modification Example 2-3 receives a drag-and-drop of the notification on the notification screen SC2 as the first operation. The first task processing execution module 205 executes first task processing based on the drop position in the drag and drop.

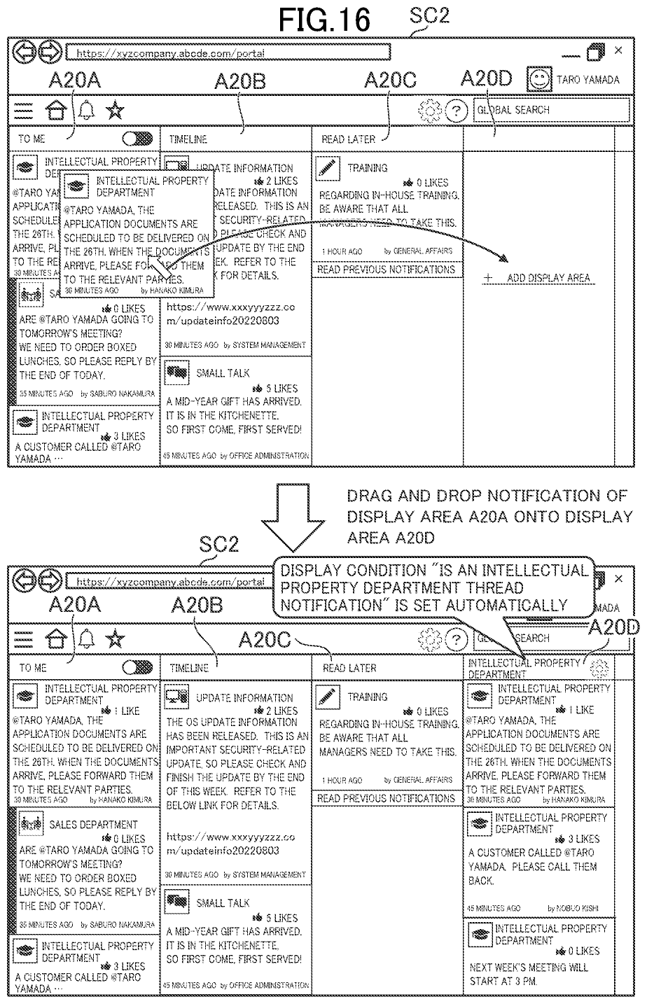

FIG. 16 is a view for illustrating an example of the notification screen SC2 in Modification Example 2-3. In the example of FIG. 16, display conditions are associated with the display areas A20A to A20C, but a display condition is not associated with the display area A20D. For example, when the user drags and drops a notification displayed in the display area A20B to the display area A20D, the first task processing execution module 205 executes the first task processing by automatically generating the display condition to be associated with the display area A20D. As illustrated in FIG. 16, not only the dragged and dropped notification but also other notifications that satisfy the automatically generated display condition are displayed in the display area A20D.

In the example of FIG. 16, a notification from the “intellectual property department” thread has been dragged and dropped, and hence the first task processing execution module 205 automatically generates a display condition indicating that the notification is from this thread. The first task processing execution module 205 requests the server 10 to associate the display condition with the display area A20D at the drop position. When the server receives the request, the server 10 stores the display area A20D and the display condition in association with each other in the user database DB1. The processing for automatically generating the display condition may be executed on the server 10 side.

The method of automatically generating the display condition is not limited to the above-mentioned example. For example, when the user drags and drops a plurality of notifications onto the display area A20D, the first task processing execution module 205 may extract a common point of the plurality of notifications and automatically generate the display condition indicating the common point. The common point may be a common point of the character strings included in the main text of the notifications, or a common point of supplementary data such as the type of the notification. For example, when “Yamada” is included as a common character string in the plurality of dragged and dropped notifications, the first task processing execution module 205 may automatically generate a display condition using this character string as a keyword.

Further, the first task processing executed based on the drop position may be other processing, and is not limited to automatic generation of the display condition. For example, turning on the read-later flag may correspond to the first task processing. In the example of FIG. 16, there may be a case in which the user has dragged and dropped a notification onto the display area A20C instead of the display area A20D. In this case, the first task processing execution module 205 may execute the first task processing such that the read-later flag of the notification dropped onto the display area A20C is turned on. The first task processing execution module 205 requests the server 10 to turn on the read-later flag of this notification.

For example, when the user has dragged and dropped a notification displayed in the display area A20C onto an area other than the display area A20C, the first task processing execution module 205 may execute the first task processing such that the read-later flag of this notification is turned off. The first task processing execution module 205 requests the server 10 to turn off the read-later flag of this notification. It is assumed that a relationship between the drop position and the first task processing is defined in a script included in the display data of the notification screen SC2. The first task processing execution module 205 may identify what first task processing is to be executed based on this relationship and the actual drop position.

The task support system 1 of Modification Example 2-3 executes the first task processing based on the drop position in a drag and drop. As a result, the first task processing can be executed by a simple operation such as dragging and dropping the notification on the notification screen SC2, thereby reducing the time and effort of the user.

### Modification Example 2-4

For example, when the first embodiment and the second embodiment are combined, the first task processing execution module 205 may execute the first task processing based on the display area A20 at the drop position among the plurality of display areas A20. In Modification Example 2-4, processing similar to that of Modification Example 1-4 is executed. In Modification Example 2-4, processing of changing the order described in Modification Example 1-4 may correspond to the first task processing, or the first task processing described in Modification Example 2-3 may be executed.

In the task support system 1 of Modification Example 2-4, the first task processing execution module 205 executes the first task processing based on the display area A20 at the drop position among the plurality of display areas A20. As a result, the first task processing can be executed by a simple operation such as dragging and dropping the notification on the notification screen SC2, thereby reducing the time and effort of the user.

### Modification Example 2-5

For example, in the second embodiment as well, similarly to Modification Example 1-5, the display control module 203 may display a notification screen SC2 which includes an index area A21 in which icons I210 relating to the plurality of display areas A20 are arranged. The icon I210 is an example of an item relating to the display area A20. Thus, in Modification Example 2-5, “icon I210” can be read as “item.” The item may be an image other than that of the icon I210.

In Modification Example 2-5, a notification screen SC2 as illustrated in FIG. 13 is displayed. The user drags and drops the notification displayed in the display area A20 onto the icon I210 in the index area A21. The first task processing execution module 205 may execute the first task processing based on the icon I210 at the drop position. It is assumed that a relationship between the icon I210 and the first task processing is defined in a script included in the display data of the notification screen SC2. The first task processing execution module 205 may identify what first task processing is to be executed based on this relationship and the actual drop position.

For example, when the user drags and drops a notification displayed in the display area A20A onto the icon I210C of the index area A21, the first task processing execution module 205 executes the first task processing such that the read-later flag of the notification is turned on. For example, when the user drags and drops a notification displayed in the display area A20A onto the icon I210D of the index area A21, the first task processing execution module 205 executes the first task processing such that information relating to the notification is added to the display condition associated with the display area A20D. For example, the display condition is changed to “main text of the notification includes the keyword ‘Yamada’ or is a to-me notification.”

The task support system 1 of Modification Example 2-5 executes the first task processing based on the icon I210 at the drop position on the notification screen SC2 including the index area A21 in which items relating to the plurality of display areas are arranged. As a result, even when the display area A20 is not displayed on the notification screen SC2, the first task processing can be executed by dragging and dropping the notification onto the icon I210 of the index area A21, thereby reducing the time and effort of the user.

### Modification Example 2-6

For example, the first operation may be an operation of selecting a notification for automatically generating a display condition. The drag and drop described in Modification Example 2-3 is also an example of this first operation. The first task processing execution module 205 may execute, as the first task processing, display condition setting processing for setting a display condition on the notification screen SC2 based on the notification received in the first operation. This first task processing is as described in Modification Example 2-3.

The display condition setting processing is not limited to processing for setting a condition for narrowing down the notifications. For example, the first task processing execution module 205 may execute the display condition setting processing in order to display a notification indicating a message from a specific user on the notification screen SC2 in a highlighted manner. In this case, the processing for setting the specific user who has transmitted the message indicated by the notification to be displayed in a highlighted manner corresponds to the display condition setting processing. As another example, the first task processing execution module 205 may execute display condition setting processing in order to display a specific character string on the notification screen SC2 in a highlighted manner. In this case, the processing for setting the character string to be displayed in a highlighted manner corresponds to the display condition setting processing.

The first operation for automatically generating the display condition is not limited to drag and drop. For example, the first operation may be an operation of selecting each of a plurality of notifications by clicking or double-clicking. In this case, the first task processing execution module 205 may extract a common point of the plurality of notifications selected in the first operation and automatically generate the display condition indicating the common point. The display area A20 associated with the automatically generated display condition may be designated by the user, or the automatically generated display condition may be associated with a newly created display area A20.

The task support system 1 of Modification Example 2-6 executes, as the first task processing, the display condition setting processing for setting a display condition on the notification screen SC2 based on the notification received in the first operation. As a result, the display condition can be automatically generated by a simple operation, thereby reducing the time and effort of the user.

### Other Modification Examples Relating to Second Embodiment

For example, Modification Examples 1-1 to 1-8 relating to the first embodiment or other modification examples may be applied to the second embodiment. For example, the display control module 203, the first operation receiving module 204A, the second operation receiving module 204B, the first task processing execution module 205, the screen transition module 206, and the second task processing execution module 207 may be implemented by the server 10. In this case, the display control module 203 of the server 10 displays the notification screen SC2 by transmitting the display data of the notification screen SC2 to the user terminal 20.

The first operation receiving module 204A of the server 10 receives the first operation by receiving data indicating that the first operation has been performed from the user terminal 20. The second operation receiving module 204B of the server 10 receives the second operation by receiving data indicating that the second operation has been performed from the user terminal 20. The first task processing execution module 205 of the server executes the first task processing by registering, changing, or deleting the data relating to the notification-related task stored in the data storage unit 100. The screen transition module 206 of the server 10 displays the transition destination screen by transmitting the display data of the transition destination screen such as the thread screen SC1 to the user terminal 20. The second task processing execution module 207 of the server 10 executes the second task processing by registering, changing, or deleting the data relating to the notification-related task stored in the data storage unit 100.

### 3-3. Other Modification Examples

For example, each function described above may be implemented by any device in the task support system 1. For example, the functions described as being implemented by the server 10 may be implemented by the user terminal 20. For example, each function may be shared by a plurality of computers.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A task support system for supporting a user in tasks, the task support system comprising at least one processor configured to:
display a notification screen relating to a notification received by the user in the task support system;
receive, on the notification screen, a first operation relating to a notification-related task associated with the notification; and
execute first task processing relating to the notification-related task based on the first operation.

2. The task support system according to claim 1,
wherein the at least one processor is configured to:
transition the notification screen to a transition destination screen associated with the notification when the notification is selected on the notification screen;
receive a second operation relating to the notification-related task on the transition destination screen; and
execute second task processing relating to the notification-related task based on the second operation, and
wherein the first operation which is receivable on the notification screen is the same as or simpler than the second operation which is receivable on the transition destination screen.

3. The task support system according to claim 2,
wherein the at least one processor is configured to display the transition destination screen as one of a pop-up of the notification screen or as a tab separate from the notification screen, and
wherein the display of the notification screen is maintained even when the transition destination screen is displayed.

4. The task support system according to claim 1, wherein the at least one processor is configured to:
receive, as the first operation, a reaction operation for making a reaction relating to the notification-related task; and
execute, based on the reaction operation, reaction processing relating to the reaction as the first task processing.

5. The task support system according to claim 1, wherein the at least one processor is configured to:
receive, as the first operation, a status change operation for changing a status relating to the notification-related task; and
execute, based on the status change operation, status change processing relating to the change of the status as the first task processing.

6. The task support system according to claim 1, wherein the at least one processor is configured to:
receive, on the notification screen, a drag-and-drop of the notification as the first operation; and
execute the first task processing based on a drop position in the drag and drop.

7. The task support system according to claim 6, wherein the at least one processor is configured to:
determine whether the notification satisfies a display condition associated with each of a plurality of display areas on the notification screen;
display the notification screen such that, in each of the plurality of display areas, the notification determined to satisfy the display condition associated with the each of the plurality of display areas is arranged; and
execute the first task processing based on, of the plurality of display areas, a display area at the drop position.

8. The task support system according to claim 1, wherein the at least one processor is configured to execute, as the first task processing, display condition setting processing for setting a display condition on the notification screen based on the notification received in the first operation.

9. A task support method, comprising:
displaying a notification screen relating to a notification received by a user in a task support system for supporting the user in tasks;
receiving, on the notification screen, a first operation relating to a notification-related task associated with the notification; and
executing first task processing relating to the notification-related task based on the first operation.

10. A non-transitory information storage medium having stored thereon a program for causing a computer to:
display a notification screen relating to a notification received by a user in a task support system for supporting the user in tasks;
receive, on the notification screen, a first operation relating to a notification-related task associated with the notification; and
execute first task processing relating to the notification-related task based on the first operation.
